(19) United States
(12) Patent Application Publication
(10) Pub. No.: US 2024/0049015 A1
(43) Pub. Date: Feb. 8, 2024

(54) TECHNIQUES FOR REPORTING CHANNEL STATE INFORMATION

(71) Applicant: QUALCOMM INCORPORATED, San Diego, CA (US)

(72) Inventors: Qiaoyu LI, Beijing (CN); Yu ZHANG, San Diego, CA (US); Liangming WU, Beijing (CN); Hao XU, Beijing (CN); Rui HU, Beijing (CN); Chenxi HAO, Beijing (CN); Taesang YOO, San Diego, CA (US)

(21) Appl. No.: 18/257,009

(22) PCT Filed: Mar. 5, 2021
(86) PCT No.: PCT/CN2021/079253

§ 371 Date: Jun. 12, 2023

(51) Int. Cl. H04W 24/08; H04W 24/10; H04L 5/00

(52) U.S. Cl. CPC H04W 24/08; H04W 24/10; H04L 5/0057

(57) ABSTRACT

Methods, systems, and devices for wireless communications are described. A user equipment (UE) may receive a first indication of a first number of antenna ports for which the UE is to report channel state information (CSI), and a second indication of a second number of antenna ports on which the UE is to measure CSI reference signals (CSI-RSs). The second number may be less than the first number. The UE may receive an indication of one or more antenna port parameters, where each may be associated with one of the first number of antenna ports or the second number of antenna ports. The UE may determine the CSI for the first number of antenna ports using the one or more antenna port parameters and measurements made by the UE on the second number of ports, and may transmit a report including the CSI for the first number of ports.

### FIELD OF TECHNOLOGY

The present Application is a 371 national stage filing of International PCT Application No. PCT/CN2021/079253 by LI et al. entitled “TECHNIQUES FOR REPORTING CHANNEL STATE INFORMATION,” filed Mar. 5, 2021, which is assigned to the assignee hereof, and which is expressly incorporated by reference in its entirety herein.

### FIELD OF TECHNOLOGY

The following relates to wireless communications, including techniques for reporting channel state information (CSI).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may be configured to perform a channel state information (CSI) determination procedure. As part of the CSI determination procedure the UE may receive, from a base station, one or more CSI reference signals (CSI-RS), where the UE may be configured to receive the one or more CSI-RSs associated with a set of CSI-RS antenna ports. The UE may measure the one or more CSI-RSs and transmit a CSI report to the base station, where the CSI report may be based on the measurements. Conventional methods for performing CSI procedures may be improved.

### SUMMARY

The described techniques relate to improved methods, systems, devices, and apparatuses that support techniques for reporting channel state information (CSI). Generally, the described techniques provide for methods for a user equipment (UE) to measure and report CSI. The UE may receive, from a base station, a first indication of a first number of antenna ports (e.g., a first set of ports) for which the UE is to report CSI, and a second indication of a second number of antenna ports (e.g., a second set of ports) on which the UE is to measure CSI-RSs. The second number of antenna ports may be less than the first number of antenna ports. The UE may receive an additional indication of one or more antenna port parameters, each associated with the first number of antenna ports and/or the second number of antenna ports. These parameters may be either an antenna port pattern or a transfer domain basis. In some cases, the UE may receive the first indication, the second indication, and/or the additional indication in the same message, or in different messages, such as in CSI report configuration messages, or CSI resource configuration messages. The UE 115 may receive one or more CSI-RSs via at least the second number of antenna ports and perform CSI measurements based on receiving the one or more CSI-RSs. The UE may determine the CSI for the first number of antenna ports based on the CSI measurements made by the UE associated with the second number of antenna ports. The UE 115 may transmit, to the base station 105, a report including the CSI associated with the first number of antenna ports.

A method for wireless communications at a UE is described. The method may include receiving a first indication of a first number of antenna ports for which the UE is to report channel state information, and a second indication of a second number of antenna ports on which the UE is to measure CSI-RSs, the second number of antenna ports being less than the first number of antenna ports, receiving an additional indication of one or more antenna port parameters, each associated with one of the first number of antenna ports or the second number of antenna ports, the one or more antenna port parameters including either an antenna port pattern or a transfer domain basis, determining the CSI-RS for the first number of antenna ports using the one or more antenna port parameters and measurements made by the UE on the second number of antenna ports, and transmitting a report including the CSI-RS for the first number of antenna ports.

An apparatus for wireless communications is described. The apparatus may include a processor, memory coupled with the processor, and instructions stored in the memory. The instructions may be executable by the processor to cause the apparatus to receive a first indication of a first number of antenna ports for which the UE is to report CSI-RS, and a second indication of a second number of antenna ports on which the UE is to measure CSI-RSs, the second number of antenna ports being less than the first number of antenna ports, receive an additional indication of one or more antenna port parameters, each associated with one of the first number of antenna ports or the second number of antenna ports, the one or more antenna port parameters including either an antenna port pattern or a transfer domain basis, determine the CSI-RS for the first number of antenna ports using the one or more antenna port parameters and measurements made by the UE on the second number of antenna ports, and transmit a report including the CSI-RS for the first number of antenna ports.

Another apparatus for wireless communications is described. The apparatus may include means for receiving a first indication of a first number of antenna ports for which the UE is to report CSI-RS, and a second indication of a second number of antenna ports on which the UE is to measure CSI-RSs, the second number of antenna ports being less than the first number of antenna ports, means for receiving an additional indication of one or more antenna port parameters, each associated with one of the first number of antenna ports or the second number of antenna ports, the one or more antenna port parameters including either an antenna port pattern or a transfer domain basis, means for determining the CSI-RS for the first number of antenna ports using the one or more antenna port parameters and measurements made by the UE on the second number of antenna ports, and means for transmitting a report including the CSI-RS for the first number of antenna ports.

A non-transitory computer-readable medium storing code for wireless communications at a UE is described. The code may include instructions executable by a processor to receive a first indication of a first number of antenna ports for which the UE is to report CSI-RS, and a second indication of a second number of antenna ports on which the UE is to measure CSI-RSs, the second number of antenna ports being less than the first number of antenna ports, receive an additional indication of one or more antenna port parameters, each associated with one of the first number of antenna ports or the second number of antenna ports, the one or more antenna port parameters including either an antenna port pattern or a transfer domain basis, determine the CSI-RS for the first number of antenna ports using the one or more antenna port parameters and measurements made by the UE on the second number of antenna ports, and transmit a report including the CSI-RS for the first number of antenna ports.

In some examples of the method, apparatuses, and non-transitory computer-readable medium described herein, receiving the additional indication of the one or more antenna port parameters may include operations, features, means, or instructions for receiving a message indicating a first set of antenna port patterns associated with the first number of antenna ports, and indicating a second set of antenna port patterns associated with the second number of antenna ports, where the second set of antenna port patterns may be a subset of the first set of antenna port patterns.

In some examples of the method, apparatuses, and non-transitory computer-readable medium described herein, receiving the message indicating the first set of antenna port patterns and the second set of antenna port patterns may include operations, features, means, or instructions for receiving the first set of antenna port patterns and the second set of antenna port patterns as a set of multiple rectangular or linear antenna arrays with inter-antenna distance information.

In some examples of the method, apparatuses, and non-transitory computer-readable medium described herein, receiving the message indicating the first set of antenna port patterns and the second set of antenna port patterns may include operations, features, means, or instructions for receiving one or more pattern indications that refer to a set of multiple predefined antenna port patterns.

In some examples of the method, apparatuses, and non-transitory computer-readable medium described herein, receiving the additional indication of the one or more antenna port parameters may include operations, features, means, or instructions for receiving a message indicating a first set of transfer domain bases associated with the first number of antenna ports, and indicating a second set of transfer domain bases associated with the second number of antenna ports, where the second set of transfer domain bases may be a subset of the first set of transfer domain bases.

Some examples of the method, apparatuses, and non-transitory computer-readable medium described herein may further include operations, features, means, or instructions for receiving the first indication, the second indication, and the additional indication via at least one of a CSI-RS report configuration or a CSI-RS resource configuration.

In some examples of the method, apparatuses, and non-transitory computer-readable medium described herein, receiving the first indication, the second, indication, and the additional indication may include operations, features, means, or instructions for receiving, via the CSI-RS report configuration, the first indication and the additional indication, where the additional indication indicates a first antenna port parameter associated with the first number of antenna ports and a second antenna port parameter associated with the second number of antenna ports and receiving, via the CSI-RS resource configuration, the second indication.

In some examples of the method, apparatuses, and non-transitory computer-readable medium described herein, receiving the first indication, the second, indication, and the additional indication may include operations, features, means, or instructions for receiving, via the CSI-RS report configuration, the second indication and the additional indication, where the additional indication indicates a first antenna port parameter associated with the first number of antenna ports and a second antenna port parameter associated with the second number of antenna ports and receiving, via the CSI-RS resource configuration, the first indication.

Some examples of the method, apparatuses, and non-transitory computer-readable medium described herein may further include operations, features, means, or instructions for receiving, via a codebook configuration within the CSI-RS report configuration, one or more codebook types that may be based on the first indication, the second indication, and the additional indication, where the additional indication indicates at least a first antenna port parameter associated with the second number of antenna ports.

In some examples of the method, apparatuses, and non-transitory computer-readable medium described herein, receiving the first indication, the second, indication, and the additional indication may include operations, features, means, or instructions for receiving, via the CSI-RS resource configuration, the first indication, the second indication, and the additional indication, where the additional indication indicates a first antenna port parameter associated with the first number of antenna ports and a second antenna port parameter associated with the second number of antenna ports.

In some examples of the method, apparatuses, and non-transitory computer-readable medium described herein, determining the CSI-RS may include operations, features, means, or instructions for identifying one or more precoding matrix indicators (PMI) for the first number of antenna ports using the one or more antenna port parameters and measurements made by the UE on the second number of antenna ports.

Some examples of the method, apparatuses, and non-transitory computer-readable medium described herein may further include operations, features, means, or instructions for receiving a message indicating a precoding matrix codebook including a set of multiple PMIs, where the one or more PMIs may be identified from the precoding matrix codebook.

In some examples of the method, apparatuses, and non-transitory computer-readable medium described herein, receiving the message indicating the precoding matrix codebook may include operations, features, means, or instructions for receiving a CSI-RS report configuration, the CSI-RS report configuration including the precoding matrix codebook.

In some examples of the method, apparatuses, and non-transitory computer-readable medium described herein, each PMI of the set of multiple PMIs may be based on the first number of antenna ports, the second number of antenna ports, the one or more antenna port parameters, or a combination thereof.

Some examples of the method, apparatuses, and non-transitory computer-readable medium described herein may further include operations, features, means, or instructions for transmitting a signal indicating a preference of the UE for selecting the second number of antenna ports, where receiving the second indication of the second number of antenna ports may be based on transmitting the signal indicating the preference.

In some examples of the method, apparatuses, and non-transitory computer-readable medium described herein, the preference includes a value of second number of antenna ports, an antenna port pattern associated with the second number of antenna ports, or a transfer domain basis associated with the second number of antenna ports, or a combination thereof.

A method for wireless communications at a base station is described. The method may include transmitting a first indication of a first number of antenna ports for which a UE is to report CSI-RS, and a second indication of a second number of antenna ports on which the UE is to measure CSI-RSs, the second number of antenna ports being less than the first number of antenna ports, transmitting an additional indication of one or more antenna port parameters, each associated with one of the first number of antenna ports or the second number of antenna ports, the one or more antenna port parameters including either an antenna port pattern or a transfer domain basis, and receiving a report including the CSI-RS for the first number of antenna ports, the CSI-RS based on the one or more antenna port parameters and measurements made by the UE on the second number of antenna ports.

An apparatus for wireless communications is described. The apparatus may include a processor, memory coupled with the processor, and instructions stored in the memory. The instructions may be executable by the processor to cause the apparatus to transmit a first indication of a first number of antenna ports for which a UE is to report CSI-RS, and a second indication of a second number of antenna ports on which the UE is to measure CSI-RSs, the second number of antenna ports being less than the first number of antenna ports, transmit an additional indication of one or more antenna port parameters, each associated with one of the first number of antenna ports or the second number of antenna ports, the one or more antenna port parameters including either an antenna port pattern or a transfer domain basis, and receive a report including the CSI-RS for the first number of antenna ports, the CSI-RS based on the one or more antenna port parameters and measurements made by the UE on the second number of antenna ports.

Another apparatus for wireless communications is described. The apparatus may include means for transmitting a first indication of a first number of antenna ports for which a UE is to report CSI-RS, and a second indication of a second number of antenna ports on which the UE is to measure CSI-RSs, the second number of antenna ports being less than the first number of antenna ports, means for transmitting an additional indication of one or more antenna port parameters, each associated with one of the first number of antenna ports or the second number of antenna ports, the one or more antenna port parameters including either an antenna port pattern or a transfer domain basis, and means for receiving a report including the CSI-RS for the first number of antenna ports, the CSI-RS based on the one or more antenna port parameters and measurements made by the UE on the second number of antenna ports.

A non-transitory computer-readable medium storing code for wireless communications at a base station is described. The code may include instructions executable by a processor to transmit a first indication of a first number of antenna ports for which a UE is to report CSI-RS, and a second indication of a second number of antenna ports on which the UE is to measure CSI-RSs, the second number of antenna ports being less than the first number of antenna ports, transmit an additional indication of one or more antenna port parameters, each associated with one of the first number of antenna ports or the second number of antenna ports, the one or more antenna port parameters including either an antenna port pattern or a transfer domain basis, and receive a report including the CSI-RS for the first number of antenna ports, the CSI-RS based on the one or more antenna port parameters and measurements made by the UE on the second number of antenna ports.

In some examples of the method, apparatuses, and non-transitory computer-readable medium described herein, transmitting the additional indication of the one or more antenna port parameters may include operations, features, means, or instructions for transmitting a message indicating a first set of antenna port patterns associated with the first number of antenna ports, and indicating a second set of antenna port patterns associated with the second number of antenna ports, where the second set of antenna port patterns may be a subset of the first set of antenna port patterns.

In some examples of the method, apparatuses, and non-transitory computer-readable medium described herein, transmitting the additional indication of the one or more antenna port parameters may include operations, features, means, or instructions for transmitting a message indicating a first set of transfer domain bases associated with the first number of antenna ports, and indicating a second set of transfer domain bases associated with the second number of antenna ports, where the second set of transfer domain bases may be a subset of the first set of transfer domain bases.

Some examples of the method, apparatuses, and non-transitory computer-readable medium described herein may further include operations, features, means, or instructions for transmitting the first indication, the second indication, and the additional indication via at least one of a CSI-RS report configuration or a CSI-RS resource configuration.

In some examples of the method, apparatuses, and non-transitory computer-readable medium described herein, transmitting the first indication, the second, indication, and the additional indication may include operations, features, means, or instructions for transmitting, via the CSI-RS report configuration, the first indication and the additional indication, where the additional indication indicates a first antenna port parameter associated with the first number of antenna ports and a second antenna port parameter associated with the second number of antenna ports and transmitting, via the CSI-RS resource configuration, the second indication.

In some examples of the method, apparatuses, and non-transitory computer-readable medium described herein, transmitting the first indication, the second, indication, and the additional indication may include operations, features, means, or instructions for transmitting, via the CSI-RS report configuration, the second indication and the additional indication, where the additional indication indicates a first antenna port parameter associated with the first number of antenna ports and a second antenna port parameter associated with the second number of antenna ports and transmitting, via the CSI-RS resource configuration, the first indication.

Some examples of the method, apparatuses, and non-transitory computer-readable medium described herein may further include operations, features, means, or instructions for transmitting, via a codebook configuration within the CSI-RS report configuration, one or more codebook types that may be based on the first indication, the second indication, and the additional indication, where the additional indication indicates at least a first antenna port parameter associated with the second number of antenna ports.

In some examples of the method, apparatuses, and non-transitory computer-readable medium described herein, transmitting the first indication, the second, indication, and the additional indication may include operations, features, means, or instructions for transmitting, via the CSI-RS resource configuration, the first indication, the second indication, and the additional indication, where the additional indication indicates a first antenna port parameter associated with the first number of antenna ports and a second antenna port parameter associated with the second number of antenna ports.

Some examples of the method, apparatuses, and non-transitory computer-readable medium described herein may further include operations, features, means, or instructions for transmitting a CSI-RS report configuration message indicating a precoding matrix codebook including a set of multiple PMIs, where each PMI of the set of multiple PMIs may be based on the first number of antenna ports, the second number of antenna ports, or the one or more antenna port parameters, or a combination thereof.

Some examples of the method, apparatuses, and non-transitory computer-readable medium described herein may further include operations, features, means, or instructions for receiving a signal indicating a preference of the UE for selecting the second number of antenna ports, the preference including a value of second number of antenna ports, an antenna port pattern associated with the second number of antenna ports, or a transfer domain basis associated with the second number of antenna ports, or a combination thereof, where transmitting the second indication of the second number of antenna ports may be based on transmitting the signal indicating the preference.

In some examples of the method, apparatuses, and non-transitory computer-readable medium described herein, transmitting the additional indication of the one or more antenna port parameters may include operations, features, means, or instructions for transmitting a message indicating a first set of antenna port patterns associated with the first number of antenna ports, and indicating a second set of antenna port patterns associated with the second number of antenna ports, where the second set of antenna port patterns may be a subset of the first set of antenna port patterns.

In some examples of the method, apparatuses, and non-transitory computer-readable medium described herein, transmitting the additional indication of the one or more antenna port parameters may include operations, features, means, or instructions for transmitting a message indicating a first set of transfer domain bases associated with the first number of antenna ports, and indicating a second set of transfer domain bases associated with the second number of antenna ports, where the second set of transfer domain bases may be a subset of the first set of transfer domain bases.

### BRIEF DESCRIPTION OF THE DRAWINGS

FIG. 1 illustrates an example of a wireless communications system that supports techniques for reporting channel state information (CSI) in accordance with aspects of the present disclosure.

FIG. 2 illustrates an example of a wireless communications system that supports techniques for reporting CSI in accordance with aspects of the present disclosure.

FIG. 3 illustrates an example of a process flow that supports techniques for reporting CSI in accordance with aspects of the present disclosure.

FIGS. 4 and 5 show block diagrams of devices that support techniques for reporting CSI in accordance with aspects of the present disclosure.

FIG. 6 shows a block diagram of a communications manager that supports techniques for reporting CSI in accordance with aspects of the present disclosure.

FIG. 7 shows a diagram of a system including a device that supports techniques for reporting CSI in accordance with aspects of the present disclosure.

FIGS. 8 and 9 show block diagrams of devices that support techniques for reporting CSI in accordance with aspects of the present disclosure.

FIG. 10 shows a block diagram of a communications manager that supports techniques for reporting CSI in accordance with aspects of the present disclosure.

FIG. 11 shows a diagram of a system including a device that supports techniques for reporting CSI in accordance with aspects of the present disclosure.

FIGS. 12 through 21 show flowcharts illustrating methods that support techniques for reporting CSI in accordance with aspects of the present disclosure.

### DETAILED DESCRIPTION

In some wireless communications systems, a user equipment (UE) may be configured, such as by a base station (or some other network device), to monitor for channel state information (CSI) reference signals (CSI-RS) associated with one or more CSI-RS antenna ports. As such, the base station may transmit a CSI-RS via one or more CSI-RS ports, and the UE may receive one or more CSI-RSs based on monitoring for the one or more CSI-RSs. The UE may be configured to perform measurements on each received CSI-RS to determine CSI associated with each received CSI-RS. In some cases, the UE may perform channel estimation for each received CSI-RS to determine CSI associated with the CSI-RS port over which the received CSI-RS was transmitted. In some cases, based on the channel estimation, the UE may determine one or more CSI parameters. For example, a CSI parameter may refer to a precoding matrix indicator (PMI), where a PMI may indicate a preferred precoder to be used for downlink transmissions from the base station to the UE.

The UE may be configured to transmit a CSI report indicating CSI for each CSI-RS port associated with a CSI-RS received by the UE. The UE may transmit a CSI report including an indication of the determined channel estimation for one or more of the received CSI-RSs, and/or one or more of the determined CSI parameters. For example, the UE may include one or more PMIs in a CSI report, and the UE may transmit the CSI report to the base station. In some cases, a UE may be configured to monitor for CSI-RSs being transmitted from a large number of CSI-RS ports (e.g., 32 CSI-RS ports, 64 CSI-RS ports), and the UE may be configured to report a large number of CSI-RSs. As such, if the UE were configured to receive and measure a large number of CSI-RSs, and transmit a CSI report for a large number of CSI-RS ports, the power consumption of the UE, and the signaling overhead associated with the CSI report may increase as the number of CSI-RS ports increases.

Techniques described herein may enable a UE to extrapolate one or more channel parameters associated with a first set of CSI-RS ports (e.g., CSI-RS antenna ports, antenna ports, PMI antenna ports) based on received indications and parameters associated with CSI-RS ports. The first set of CSI-RS ports may include a first number of CSI-RS ports, and the second set of CSI-RS ports may include a second number of CSI-RS ports, where the second number may be less than the first number. For example, the UE may receive a first indication of the first set of CSI-RS ports (e.g., first number of CSI-RS ports) for which the UE is to report CSI on and may receive a second indication of a second set of CSI-RS ports (e.g., second number of CSI-RS ports) on which the UE is to measure CSI. The second set of CSI-RS ports may include a fewer number of CSI-RS ports than the first set of CSI-RS ports. In some cases, the UE may receive an additional indication of one or more antenna port parameters, which may be associated with the first set and/or the second set of CSI-RS ports. For example, the additional indication may include a first set of antenna port patterns associated with the first set of CSI-RS ports, a second set of antenna port patterns associated with the second set of CSI-RS ports, a first set of transfer domain bases associated with the first set of CSI-RS ports, or a second set of transfer domain basis associated with the second set of CSI-RS ports. In some cases, the second set of CSI-RS ports may be a subset of the first set of CSI-RS ports and the UE may determine the second set of CSI-RS ports based on the first set of CSI-RS ports.

In some cases, the first indication, the second indication, and the third indication may be transmitted in the same message, or in different messages. For example, the first indication, the second indication, and/or the additional indication may be transmitted in a message associated with configuring a CSI report (e.g., CSI-ReportConfig message). Any indication of the first indication, the second indication, or the additional indication not included in the CSI report configuration message may be included in a different message, such as a message associated with configuring CSI resources (e.g., CSI-ResourceConfig message). In another example, the first indication, the second indication, and/or the additional indication may be transmitted in a CSI resource configuration message and any indication of the first indication, the second indication, or the additional indication not included in the CSI resource configuration message may be included in a different message, such as a CSI report configuration message.

Particular aspects of the subject matter described herein may be implemented to realize one or more advantages. The described techniques may support improvements in CSI measurement and reporting by decreasing signaling overhead, decreasing power consumption of a device (e.g., a UE), and decreasing latency among other advantages. As such, supported techniques may include improved network operations and, in some examples, may promote network efficiencies, among other benefits.

Aspects of the disclosure are initially described in the context of wireless communications systems. Aspects are then described with reference to a process flow. Aspects of the disclosure are further illustrated by and described with reference to apparatus diagrams, system diagrams, and flowcharts that relate to techniques for reporting CSI.

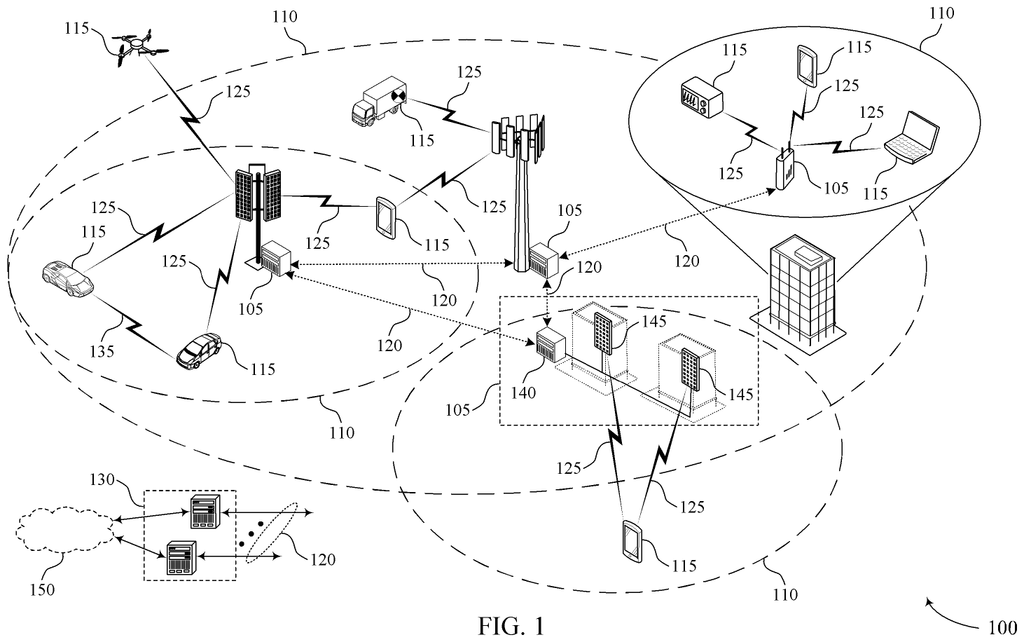

FIG. 1 illustrates an example of a wireless communications system 100 that supports techniques for reporting CSI in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for transmitting control information to multiple UEs 115 and UE-specific search space sets for transmitting control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI reference signal (CSI-RS)), which may be precoded or unprecoded. The UE 115 may provide feedback for beam selection, which may be a PMI or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

A UE 115 may receive, from a base station 105 (or some other network device), a first indication of a first number of antenna ports (e.g., a first set of ports) for which the UE 115 is to report CSI, and a second indication of a second number of antenna ports (e.g., a second set of ports) on which the UE 115 is to measure CSI-RSs. The second number of antenna ports may be less than the first number of antenna ports. The UE 115 may receive an additional indication of one or more antenna port parameters, each associated with the first number of antenna ports and/or the second number of antenna ports. These parameters may be either an antenna port pattern or a transfer domain basis. In some cases, the UE 115 may receive the first indication, the second indication, and/or the additional indication in the same message, or in different messages, such as in CSI report configuration messages, or CSI resource configuration messages. The UE 115 may receive one or more CSI-RSs via at least the second number of antenna ports and perform CSI measurements based on receiving the one or more CSI-RSs. The UE may determine the CSI for the first number of antenna ports based on the CSI measurements made by the UE associated with the second number of antenna ports. The UE 115 may transmit, to the base station 105 (or some other network device), a report including the CSI associated with the first number of antenna ports. As such, the UE 115 may provide CSI reporting to the base station or other network device.

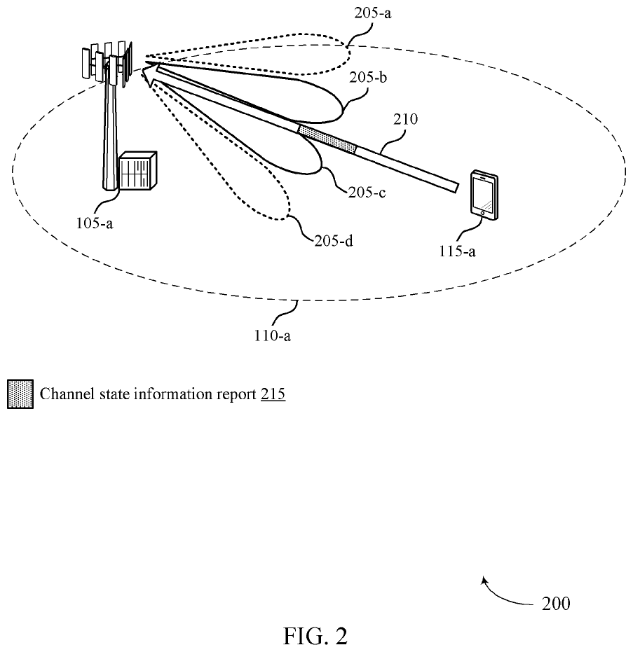

FIG. 2 illustrates an example of a wireless communications system 200 that supports techniques for reporting CSI in accordance with aspects of the present disclosure. The wireless communications system 200 may include base station 105-a and UE 115-a, which may be examples of a base station 105 and a UE 115 as described with reference to FIG. 1. Base station 105-a may serve a geographic coverage area 110-a. In some cases, UE 115-a may perform a channel measurement and reporting procedure, such as CSI measurement and reporting. Additionally or alternatively, other wireless devices, such as a base station 105, may implement a same or similar channel measurement and reporting procedure.

In some cases, a base station 105 and a UE 115 may support directional transmissions and may communicate via one or more directional beams. For example, base station 105-a and UE 115-a may communicate via transmit beams 205 or receive beams, or both, and may perform directional transmissions using a directional beam over a communication link 210. Further, the directional beams used by base station 105-a and UE 115-a may be associated with a channel or a medium between base station 105-a and UE 115-a. As such, base station 105-a and UE 115-a may communicate via the communication link 210 using one or more beams associated with one or more channels. In some aspects, the communication link 210 may be a line-of-sight link or involve a relatively small number of reflections (e.g., may be a non-line-of-sight link including one or more reflections).

In some cases, the radio environment between base station 105-a and UE 115-a may change, which may affect the quality of the beam or the channel, or both, used by base station 105-a and UE 115-a. For example, the UE 115-a may move (e.g., change physical location) or an object may become present between base station 105-a and UE 115-a, which may affect the signal strength or signal quality, or both, of transmissions between UE 115-a and base station 105-a. Additionally, in some systems that support relatively higher frequency communication, such as NR systems operating in FR2 radio frequency spectrum bands, a change in the radio environment between base station 105-a and UE 115-a may have a more pronounced influence on the quality of the beam or the channel. Further, in such systems supporting relatively higher frequency communication, changes in the radio environment between base station 105-a and UE 115-a may result in sudden changes (e.g., small time-scale changes) in the quality of the beam or the channel used by the base station 105-a and the UE 115-a. In some cases, such changes in the radio environment between base station 105-a and UE 115-a may decrease the likelihood for successful communication between base station 105-a and UE 115-a.

To maintain reliable communications between base station 105-a and UE 115-a, base station 105-a and UE 115-a may perform one or more beam management procedures. In some cases, based on performing a beam management procedure, base station 105-a may transmit one or more reference signals, such as CSI-RSs, SSBs, DMRSs, via one or more beams 205 (e.g., each CSI-RS may be transmitted by base station 105-a using a different directional beam) over a channel between base station 105-a and UE 115-a. In some cases, each beam 205 (each channel) may be associated with an antenna port. An antenna port may refer to a logical entity used to map data streams to antennas. A given antenna port may drive transmissions from one or more antennas (e.g., and resolve signal components received over one or more antennas). In some cases, each antenna port may be associated with a reference signal (e.g., which may allow the receiver to distinguish data streams associated with the different antenna ports in a received transmission). As such, each beam, and thus each channel, may be transmitted (e.g., formed) by an antenna port. In some cases, antenna ports may be configured for reference signal transmissions, where one or more antenna ports (e.g., one antenna port or greater, such as 2, 4, 8, 12, 16, 24, 32 antenna ports, or any number of antenna ports greater than 32, such 64) may be configured for CSI-RS transmissions by a base station 105. In some cases, transmissions via multiple antenna ports may be multiplexed such as by TDM, FDM or code division multiplexing (CDM).

A base station 105, or some other network device, may configure a UE 115 to monitor for CSI-RS transmissions from the base station 105, and to report CSI associated with any received CSI transmissions by the UE 115. For example, a UE 115 may receive a CSI report configuration (e.g., CSI-ReportConfig) that may indicate a number of CSI-RS antenna ports, a density (e.g., resource element (RE) density, physical resource block (PRB) density, or antenna port density, or a combination thereof), one or more multiplexing parameters (e.g., CDM length, CDM type), a location (e.g., time, frequency location) of the component RE patterns for the corresponding CSI-RS resource, or a scrambling ID, or a combination thereof. The UE 115 may receive the CSI report configuration periodically, semi-statically, or aperiodically, such as via a downlink control information (DCI), MAC control element (MAC-CE), or RRC message. In some cases, the UE 115 may receive a CSI resource configuration (e.g., CSI-ResourceConfig) that may indicate a set of CSI resources to be used for CSI-RS transmissions. For example, the CSI resource configuration may indicate that one or more NZP CSI-RS resources may be used for the transmissions of one or more CSI-RS transmissions. The UE 115 may receive the CSI report configuration periodically, semi-statically, or aperiodically, such as via a DCI, MAC-CE, or RRC message.

In some cases, the CSI report configuration, the CSI resource configuration, or some other message, may trigger the UE 115 to monitor for CSI-RS transmissions from the base station 105, based on the CSI report configuration and CSI resource configuration. Accordingly, the UE 115 may receive and perform CSI measurements for received CSI-RS transmissions, where each CSI-RS transmission may be transmitted via a different CSI-RS port. In some cases, the UE 115 may measure one or more parameters of the CSI-RS transmission such as signal quality (e.g., RSRQ), signal power (e.g., reference signal received power (RSRP)), a level of interference (e.g., signal to interference plus noise (SINR)), or a combination thereof. The UE 115 may measure a CSI-RS and may use the measurements to perform channel estimation, such as channel estimation of the channel associated with the CSI-RS port over which the CSI-RS was transmitted. The CSI-RS transmissions the UE 115 measures may be periodic CSI-RS transmissions, aperiodic CSI-RS transmissions, semi-persistent CSI-RS transmissions, or a combination. In some cases, the UE may determine one or more additional CSI parameters based on the channel estimation, such as rank indicators (RIs), PMIs, and/or channel quality indicators (CQIs). The UE 115 transmit a CSI report to the base station 105 including one or more parameters based on the CSI measurements. In some examples, the CSI report may include one or more PMIs, RIs, layer indicators (LIs), CQIs, RSRP measurements (such as Layer 1-RSRPs (L1-RSRPs)), SINR measurements (such as L1-SINRs), or the like. In some examples, the UE 115 may perform periodic CSI reporting (such as the base station 105 may transmit higher layer signaling scheduling periodic CSI reports), aperiodic CSI reporting (such that the base station 105 may dynamically configure a CSI report), semi-persistent CSI reporting (such that the base station 105 may transmit higher layer signaling scheduling periodic CSI reports and may use dynamic signaling to trigger the periodic CSI reporting), or a combination thereof. In some cases, as the number of CSI-RS ports the UE 115 is configured to receive CSI-RS transmissions from increases, and thus, as the number of CSI-RS transmissions to report on increases, the power consumption of the UE 115 may increase, and reporting overhead may increase.

To reduce power consumption and signaling overhead, UE 115-a may be configured to extrapolate one or more channel parameters associated with a first set of CSI-RS ports (e.g., CSI-RS antenna ports, antenna ports, PMI antenna ports) based on performing CSI measurements on a second set of CSI-RS ports (e.g., CSI-RS antenna ports, antenna ports). The first set of CSI-RS ports may include a first number of CSI-RS ports, and the second set of CSI-RS ports may include a second number of CSI-RS ports, where the second number may be less than the first number. As such, UE 115-a may receive, from base station 105-a or some other network device, a first indication of the first number of CSI-RS ports (e.g., first set of CSI-RS ports) for which UE 115-a is to report CSI on. In some cases, UE 115-a may receive a second indication of a second number of CSI-RS ports (e.g., second set of CSI-Rs ports) on which UE 115-a is to measure CSI-RSs on, where the second number may be less than the first number. In some examples, the UE 115-a may receive an additional indication including one or more antenna port parameters associated with the first number of CSI-RS ports, or the second number of CSI-RS ports, or a combination thereof. In some cases, the one or more antenna parameters may indicate one or more antenna port patterns, or one or more transfer domain basis, or a combination thereof.

For example, UE 115-a may receive an indication or determine that the second number of CSI-RS ports may include a first CSI-RS port and a second CSI-RS port. The first CSI-RS port may be associated with beam 205-b (e.g., the first CSI-RS port forms beam 205-b, the first CSI-RS port transmits a CSI-RS via beam 205-b) and the second CSI-RS port may be associated with beam 205-c (e.g., the second CSI-RS port forms beam 205-c, the second CSI-RS port transmits a CSI-RS via beam 205-c). As such, UE 115-a may receive a CSI-RS transmission via beam 205-b and a CSI-RS transmission via beam 205-c (but not via beam 205-a, or beam 205-d). UE 115-a may perform one or more channel measurements on the CSI-RS transmissions received via beam 205-b and 205-c.

In some cases, the second number of CSI-RS ports may indicate a set of CSI-RS ports that the UE 115-a may measure a CSI-RS from. For example, UE 115-a may receive an indication or determine that the second number of CSI-RS ports may include a first CSI-RS port and a second CSI-RS port. The first CSI-RS port may be associated with beam 205-b and the second CSI-RS port may be associated with beam 205-c. In some cases, UE 115-a may receive a CSI-RS transmission via beam 205-a, a CSI-RS transmission via beam 205-b, a CSI-RS transmission via beam 205-c, or a CSI-RS transmission via beam 205-d, or a combination thereof. However, as the second set of CSI-RS ports indicated the first CSI-RS port associated with beam 205-b and the second CSI-RS port associated with beam 205-c, UE 115-a may perform one or more channel measurements on the CSI-RS transmissions received via beam 205-b and 205-c (but not via beam 205-a, or 205-d).

In either case, UE 115-a may perform CSI measurements associated with CSI-RS ports included in the second number of CSI-RS ports. UE 115-a may be configured to use the CSI measurements associated with the second number of CSI-RS ports to extrapolate CSI associated with the first number of CSI-RS ports. For example, UE 115-a may receive an indication that the first number of CSI-RS ports may include a first CSI-RS port associated with beam 205-a, a second CSI-RS port associated with beam 205-b, a third CSI-RS port associated with beam 205-c, and a fourth CSI-RS port associated with beam 205-d. As such, UE 115-a may be configured to determine CSI for a larger number of CSI-RS ports than the number of ports the UE 115-a performed a measurement on. UE 115-a may perform such an extrapolation via the one or more indicated neural networks 220.

In some cases, to perform the extrapolation procedure to determine the CSI for the first set of ports, UE 115-a may utilize one or more parameters associated one or more antenna port parameters associated with the first number of CSI-RS ports and/or one or more antenna port parameters associated with the first number of CSI-RS ports. For example, the one or more parameters may include one or more sets of antenna port patterns, where a set of antenna port patterns may include one or more antenna port patterns. Antenna ports may be associated with an antenna port pattern that is related to a pattern of physical antennas (e.g., including any number of physical antennas) in an antenna array at the base station 105. An antenna port pattern may indicate a number of active antenna elements, an identifier of the active antenna elements, the shape the antenna array (e.g., linear, rectangular), an inter-antenna element distance, etc. In such an example, the first number of CSI-RS ports may be associated with all of the antennas in an antenna panel, and the second number of CSI-RS ports may be associated with a subset of the antennas in the panel.

As such, the first number of antenna ports may be associated with a first set of antenna port patterns, where each antenna port of the first number of antenna ports may be associated with an antenna port pattern included in the first set of antenna port patterns. The second number of antenna ports may be associated with a second set of antenna port patterns, where each antenna port of the second number of antenna ports may be associated with an antenna port pattern included in the second set of antenna port patterns. The second set of antenna port patterns may be a subset of the first set of antenna port patterns. The one or more parameters in the additional indication may indicate the first set of antenna port patterns and/or the second set of antenna port patterns.

In another example, the one or more parameters included in the additional indication may include a set of transfer domain bases, where the set of transfer domain bases may include one or more transfer domain bases. In some such examples, each port may be associated with a transfer domain basis instead of an antenna port pattern and UE 115-a may not explicitly receive an indication of what kind of pattern base station 105-a may be using. Rather, UE 115-a may implicitly derive the patterns being used. For example, PMI ports may be as associated with a set of n Discrete Fourier Transform (DFT) bases (e.g., where n may be equal to 32), and UE 115-a may be configured to identify that y CSI-RS ports (e.g., where y may be equal to 8) are associated with m of the n DFT bases (e.g., where m may be equal to 8). By analyzing the DFT bases, UE 115-a may identify the structure of one or more antenna port patterns. Another example may utilize a matrix with n DFT bases (e.g., where n may be equal to 32) contained therein. UE 115-a may identify that y CSI-RS ports (e.g., where y may be equal to 8) ports may be associated with m of the n DFT bases (e.g., where m may be equal to 8) in the matrix, and that UE 115-a may additionally be configured to report an n port PMI using each of said bases (or a different PMI using a different number of basis). Once again, by analyzing the DFT bases, UE 115-a may identify the structure of one or more antenna port patterns. Using DFT bases or other transfer domain bases to determine antenna port patterns may advantageously utilize structural nature of the antennas of base station 105-a. As such, the one or more parameters included in the additional indication may indicate a first set of transfer domain bases associated with the first number of CSI-RS ports and indicate a second set of transfer domain bases associated with the second number of CSI-RS ports. The second set of transfer domain bases may be a subset of the first set of transfer domain bases.

In some implementations, base station 105-a may transmit, to UE 115-a, various messages to configure one or more CSI parameters, such as parameters associated with CSI measurement and reporting. Some examples of such messages may include a report settings message (e.g., a CSI-ReportConfig message) and/or a resource settings message (e.g., a CSI-ResourceConfig). Such messages may be transmitted in an RRC message. Various parameters may be configured or included within either or both of a report settings message and a resource settings message. The examples described herein include various parameters and configurations, and these examples may be combined, aggregated, or used together in various combinations.

For example, base station 105-a may transmit, to UE 115-a, a resource settings message that may indicate one or more resource settings (e.g., a resource configuration) associated with receiving one or more CSI-RSs. In some cases, the one or more resource settings may indicate one or more parameters associated with channel measurements, such as CSI measurements associated with the received CSI-RSs. In some cases, the resource settings message may indicate a type of reference signal base station 105-a may transmit (e.g., nzp_CSI_RS_SSB). In some cases, the resource settings message may indicate a type of resource, such as whether base station 105-a is transmitting the one or more CSI-RSs periodically, semi-persistently, or aperiodically. In some cases, the resource settings message may indicate time and/or frequency resources over which base station 105-a may transmit the one or more reference signals. As such, UE 115-a may receive a resource settings message and identify one or more parameters associated with receiving and measuring one or more CSI-RSs.

In some examples, base station 105-a may configure UE 115-a to perform CSI reporting (e.g., configuring and transmitting one or more CSI reports) by indicating one or more parameters in the report settings message. In some examples, one or more resource settings may be a subset of the reporting settings. In some examples, base station 105-a may transmit a report settings message that may indicate a resource configuration for UE 115-a to use for measurement of one or more CSI-RSs transmitted by base station 105-a.

In some implementations, base station 105-a may indicate the first number of CSI-RS ports, the second number of CSI-RS ports, or the one or more parameters associated with the first number and/or the second number of CSI-RS ports (e.g., antenna patterns, transfer domain bases), or a combination thereof in the report settings message, the resource settings message, or a combination thereof. In some cases, base station 105-a may indicate the first number of CSI-RS ports, the second number of CSI-RS ports, and the one or more parameters in the same message or in different message. In some implementations, a resource settings message may (e.g., conventionally) include a field indicating a number of CSI-RS ports for a UE 115 to measure and report on. In some cases, said field may be used to indicate the first number of CSI-RS ports and base station 105-a may include one or more fields in the resource settings message and/or a report settings message to indicate the second number of CSI-RS ports, the one or more parameters associated with the first number, or one or more parameters associated with the second number of CSI-RS ports, or a combination thereof. In some cases, said field may be used to indicate the second number of CSI-RS ports and base station 105-a may include one or more fields in the resource settings message and/or a report settings message to indicate the first number of CSI-RS ports, the one or more parameters associated with the first number of CSI-RS ports, or one or more parameters associated with the second number of CSI-RS ports, or a combination thereof.

In some implementations, base station 105-a may indicate the first number of CSI-RS ports, one or more antenna parameters associated with the first number of CSI-RS ports, as well as the second number of CSI-RS ports and the one or more antenna parameters associated with the second number of CSI-Rs ports in a resource settings message. Base station 105-a may transmit the resource settings message to UE 115-a. In another implementation, base station 105-a may indicate the first number of CSI-RS ports, one or more antenna parameters associated with the first number of CSI-RS ports, as well as the second number of CSI-RS ports and the one or more antenna parameters associated with the second number of CSI-Rs ports in a report settings message. Base station 105-a may transmit the report settings message to UE 115-a.

In another example, base station 105-a may include, in a report settings message, the first number of antenna ports and one or more antenna parameters associated with the first number of antenna ports. In some cases, base station 105-a may additionally transmit in the report settings message an indication of one or more antenna parameters associated with the second number of antenna ports. In some such examples, base station 105-a may transmit an indication of the second number of antenna ports in a resource settings message.

In another example, base station 105-a may transmit a report settings message that may indicate the second number of CSI-RS ports and one or more antenna parameters associated with the second number of CSI-RS ports, along with the one or more antenna parameters associated with the first number of CSI-RS ports. In some such examples, base station 105-a may transmit an indication of the first number of CSI-RS ports in a resource settings message.

In some cases, base station 105-a may indicate the first number of CSI-RS ports in a report settings message and indicate the second number of CSI-RS ports, the one or more parameters associated with the first number of CSI-RS ports, and the one or more parameters associated with the second number of CSI-RS ports in a resource settings message. In some cases, base station 105-a may indicate the second number of CSI-RS ports in a report settings message and indicate the first number of CSI-RS ports, the one or more parameters associated with the first number of CSI-RS ports, and the one or more parameters associated with the second number of CSI-RS ports in a resource settings message.

In some cases, base station 105-a may indicate the first number of CSI-RS ports, and the one or more parameters associated with the first number of CSI-RS ports in a report settings message and may indicate the second number of CSI-RS ports, and the one or more parameters associated with the second number of CSI-RS ports in a resource settings messages. In some cases, base station 105-a may indicate the first number of CSI-RS ports, and the one or more parameters associated with the first number of CSI-RS ports in a resource settings message and may indicate the second number of CSI-RS ports, and the one or more parameters associated with the second number of CSI-RS ports in a report settings messages.

For example, base station 105-a may indicate 8 CSI-RS ports (e.g., the second number of CSI-RS ports) in a resource settings message and may transmit the resource settings message to UE 115-a. In addition, base station 105-a may indicate 32 PMI antenna ports (e.g., the first number of antenna ports), antenna parameters associated with the 8 CSI-RS ports, and antenna parameters associated with the 32 PMI ports in a report settings message and transmit the report setting message to UE 115-a.

In some examples, base station 105-a may transmit an indication of one or more codebook types to UE 115-a that may be utilized with the approaches described herein. For example, UE 115-a may determine one or more CSI indicators, such a PMI, from one or more codebooks. AS such, UE 115-a may be configured with one or more codebooks, or base station 105-a transmit an indication to UE 115-a of the one or more codebooks. In some cases, the one or more codebooks may be based on the first number of CSI-RS ports, the one or more antenna parameters associated with the first number of CSI-RS ports, the second number of CSI-RS ports, or the one or more antenna parameters associated with the second number of CSI-RS ports, or a combination thereof. Base station 105-a may transmit an indication of the one or more codebooks to UE 115-a via codebook configuration message (e.g., CodebookConfig). Such a codebook configuration message may be included in the reporting settings message (e.g., CSI-ReportConfig), or may be included in some other message. The reporting settings message may be transmitted via RRC signaling. Some implementations may include Type-I or Type-II PMI, and the codewords may depend on values of the first number of CSI-RS ports, the second number of CSI-RS ports, antenna parameters associated with the first number of CSI-RS ports, or antenna parameters associated with the second number of CSI-RS ports, or any combination thereof.

In some implementations, UE 115-a may identify a preference of UE 115-a for selecting the second number of CSI-RS ports, and UE 115-a may transmit, to base station 105-a, an indication of such preference. For example, UE 115-a may indicate a preference for selecting the second number of CSI-RS ports based on the first number of CSI-RS ports. UE 115-a may transmit an indication of the preference of UE 115-a via an RRC message, an uplink control information (UCI) message, or a MAC-CE message. In some cases, UE 115-a may indicate a number CSI-RS ports in the preference. In some cases, UE 115-a may indicate one or more parameters associated with the second number of CSI-RS ports in the preference. For example, UE 115-a may recommend one or more antenna port patterns for the second number of CSI-RS ports, or one or more transfer domain bases associated with the second number of CSI-RS ports, or both. In some cases, the one or more parameters associated with the second number of CSI-RS ports included in the preference may be based on one or more parameters associated with the first number of CSI-RS ports. Base station 105-a may configure CSI measurement and reporting settings based on the preference of UE 115-a.

After receiving the configuration information described herein (e.g., resource settings, reporting settings, or other configuration information that may configure or indicate various number of CSI-RS ports and associated port parameters), UE 115-a may receive one or more CSI-RSs to determine CSI on one or more channels. In some cases, UE 115-a may receive a CSI-RS on each CSI-RS port included in the first number of CSI-RS ports, or may receive a CSI-RS on each CSI-RS port included in the second number of CSI-RS ports. UE 115-a may perform one or more measurements based on the one or more CSI-RSs received from the second number of CSI-RS ports to determine the CSI for one or more channels associated with the second number of CSI-RS ports. In some cases, UE 115-a may be configured to determine a PMI based on each CSI-RS received from a CSI-RS port from the second number of CSI-RS ports.

UE 115-a may be configured to determine CSI for each of the first number of CSI-RS ports based on the CSI determined for each of the second number of CSI-RS ports. In some cases, UE 115-a may determine the CSI for each of the first number of CSI-RS ports by performing one or more extrapolation procedures based on the CSI determined for each of the second number of CSI-RS ports. In some implementations, UE 115-a may be configured with one or more neural networks that UE 115-a may use to determine CSI for each of the first number of CSI-RS ports based on the CSI determined for each of the second number of CSI-RS ports.

As such, UE 115-a may determine CSI, such as PMI, for each antenna port included in the first number of antenna ports based on the CSI, such as PMI, for each antenna port included in the second number of antenna ports, where the second number of antenna ports includes a fewer number of antenna ports than the first number of antenna ports. UE 115-a may transmit one or more CSI reports 215 to base station 105-a to indicate the CSI associated with the first number of CSI-RS ports.

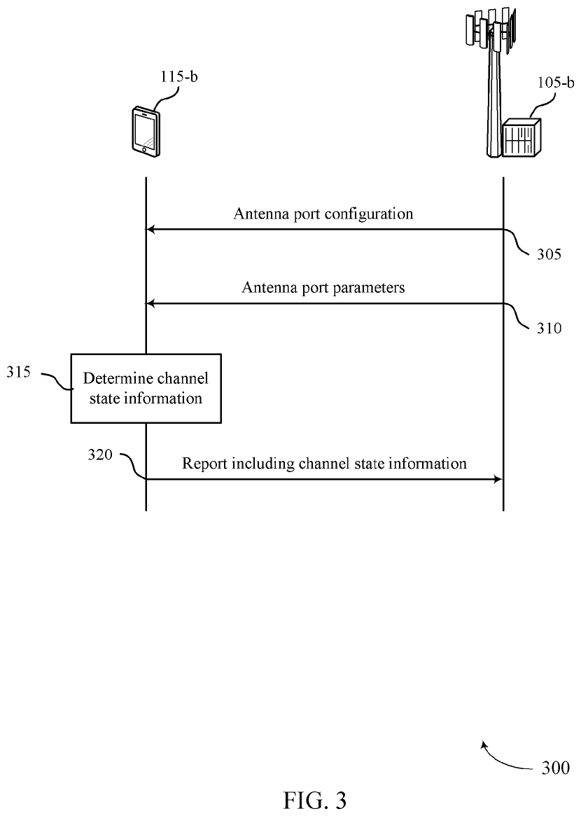

FIG. 3 illustrates an example of a process flow 300 that supports techniques for reporting CSI in accordance with aspects of the present disclosure. The process flow 300 may illustrate an example CSI reporting procedure. For example, UE 115-b may perform a CSI reporting procedure with base station 105-b. Base station 105-b and UE 115-b may be examples of the corresponding wireless devices described with reference to FIGS. 1 through 2. In some cases, instead of UE 115-b implementing the reporting procedure, a different type of wireless device (e.g., a base station 105) may perform a same or similar CSI reporting procedure. Alternative examples of the following may be implemented, where some steps are performed in a different order than described or are not performed at all. In some cases, steps may include additional features not mentioned below, or further steps may be added.

At 305, UE 115-b may receive a first indication of a first number of antenna ports (e.g., a first set of antenna ports) for which UE 115-b is to report CSI, and a second indication of a second number of antenna ports (e.g., a second set of antenna ports) on which UE 115-b is to measure CSI-RSs. The second number of antenna ports may be less than the first number of antenna ports.

At 310, UE 115-b may receive an additional indication of one or more antenna port parameters, each of which may be associated with one of the first number of antenna ports or the second number of antenna ports. In some examples, the one or more antenna port parameters may include either an antenna port pattern or a transfer domain basis. The one or more antenna port parameters may also include other parameters than antenna port patterns or transfer domain bases.

In some implementations, UE 115-b may receive a message indicating a first set of antenna port patterns that may be associated with the first number of antenna ports, and that may indicate a second set of antenna port patterns associated with the second number of antenna ports. In some examples, the second set of antenna port patterns may be a subset of the first set of antenna port patterns.

In some implementations, UE 115-b may receive the first set of antenna port patterns and the second set of antenna port patterns as one or more rectangular or linear antenna arrays, that may include inter-antenna distance information. In some implementations, UE 115-b may receive one or more pattern indications that refer to one or more predefined antenna port patterns.

In some implementations, UE 115-b may receive a message indicating a first set of transfer domain bases (e.g., DFT bases) associated with the first number of antenna ports, and indicating a second set of transfer domain bases associated with the second number of antenna ports. In some implementations, the second set of transfer domain bases may be a subset of the first set of transfer domain bases.

In some implementations, UE 115-b may receive the first indication, the second indication, and the additional indication via at least one of a CSI report configuration (e.g., CSI-ReportConfig) or a CSI resource configuration (e.g., CSI-ResourceConfig).

In some implementations, UE 115-b may receive, via the CSI report configuration, the first indication and the additional indication, where the additional indication may indicate a first antenna port parameter associated with the first number of antenna ports and a second antenna port parameter associated with the second number of antenna ports. UE 115-b may further receive, via the CSI resource configuration, the second indication.

In some implementations, UE 115-b may receive, via the CSI report configuration, the second indication and the additional indication, where the additional indication may indicate a first antenna port parameter associated with the first number of antenna ports and a second antenna port parameter associated with the second number of antenna ports. UE 115-b may further receive, via the CSI resource configuration, the first indication.

In some implementations, UE 115-b may receive, via a codebook configuration (e.g., CodebookConfig) within the CSI report configuration, one or more codebook types that may be based on the first indication, the second indication, and the additional indication, where the additional indication may indicate at least a first antenna port parameter associated with the second number of antenna ports.

In some implementations, UE 115-b may receive, via the CSI resource configuration, the first indication, the second indication, and the additional indication, where the additional indication may indicate a first antenna port parameter associated with the first number of antenna ports and a second antenna port parameter associated with the second number of antenna ports.

In some implementations, UE 115-b may receive the first indication, the second indication, and the additional indication in a same message. In some implementations, UE 115-b may receive the first indication and the additional indication in a same message. In some implementations, UE 115-b may receive the second indication and the additional indication in a same message.

In some cases, the second number of antenna ports may be a subset of the first number of antenna ports.

At 315, UE 115-b may determine the CSI for the first number of antenna ports using the one or more antenna port parameters and measurements made by the UE on the second number of antenna ports. As discussed herein, this may be done by means of one or more neural networks or via one or more extrapolation procedures.

In some implementations, UE 115-b may identify one or more PMIs for the first number of antenna ports using the one or more antenna port parameters and measurements made by UE 115-b on the second number of antenna ports. In some implementations, UE 115-b may receive a message indicating a precoding matrix codebook that may include a set of PMIs, where the one or more PMIs may be identified from the precoding matrix codebook. In some implementations, UE 115-b may receive a CSI report configuration, and the CSI report configuration may include the precoding matrix codebook. In some cases, each PMI of the set of PMIs may be based on the first number of antenna ports, the second number of antenna ports, the one or more antenna port parameters, or a combination thereof.

In some implementations, UE 115-b may transmit a signal indicating a preference of UE 115-b for selecting the second number of antenna ports, where receiving the second indication of the second number of antenna ports may be based on transmitting the signal indicating the preference. In some cases, the preference may include a value of second number of antenna ports, an antenna port pattern associated with the second number of antenna ports, or a transfer domain basis associated with the second number of antenna ports, or a combination thereof. In some cases, the signal indicating the preference may be transmitted in a RRC message, a MAC-CE message, or an uplink control information message.

At 320, UE 115-b may transmit a report including the CSI for the first number of antenna ports.

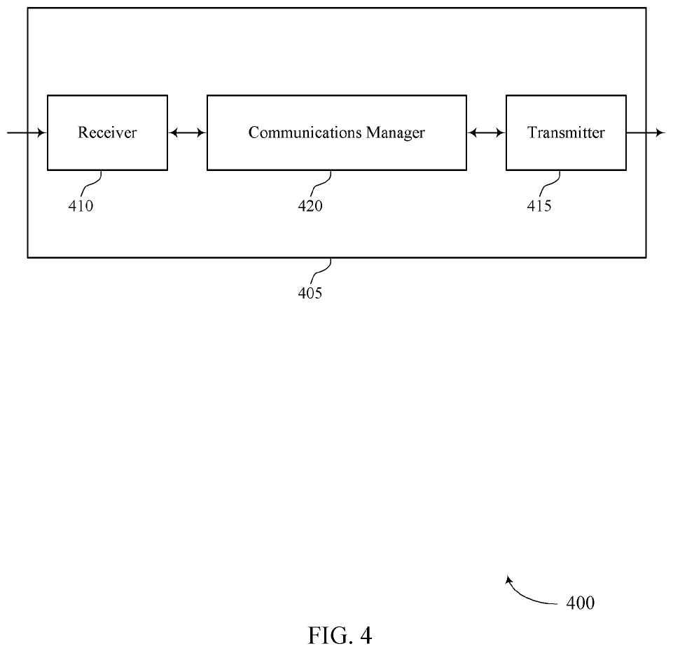

FIG. 4 shows a block diagram 400 of a device 405 that supports techniques for reporting CSI in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for reporting CSI). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for reporting CSI). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for reporting CSI as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, transmit information to the transmitter 415, or be integrated in combination with the receiver 410, the transmitter 415, or both to receive information, transmit information, or perform various other operations as described herein.

The communications manager 420 may support wireless communications at a UE in accordance with examples as disclosed herein. For example, the communications manager 420 may be configured as or otherwise support a means for receiving a first indication of a first number of antenna ports for which the UE is to report CSI, and a second indication of a second number of antenna ports on which the UE is to measure CSI-RSs, the second number of antenna ports being less than the first number of antenna ports. The communications manager 420 may be configured as or otherwise support a means for receiving an additional indication of one or more antenna port parameters, each associated with one of the first number of antenna ports or the second number of antenna ports, the one or more antenna port parameters including either an antenna port pattern or a transfer domain basis. The communications manager 420 may be configured as or otherwise support a means for determining the CSI for the first number of antenna ports using the one or more antenna port parameters and measurements made by the UE on the second number of antenna ports. The communications manager 420 may be configured as or otherwise support a means for transmitting a report including the CSI for the first number of antenna ports.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced CSI-RS overhead, reduced processing, reduced power consumption, and more efficient utilization of communication resources.

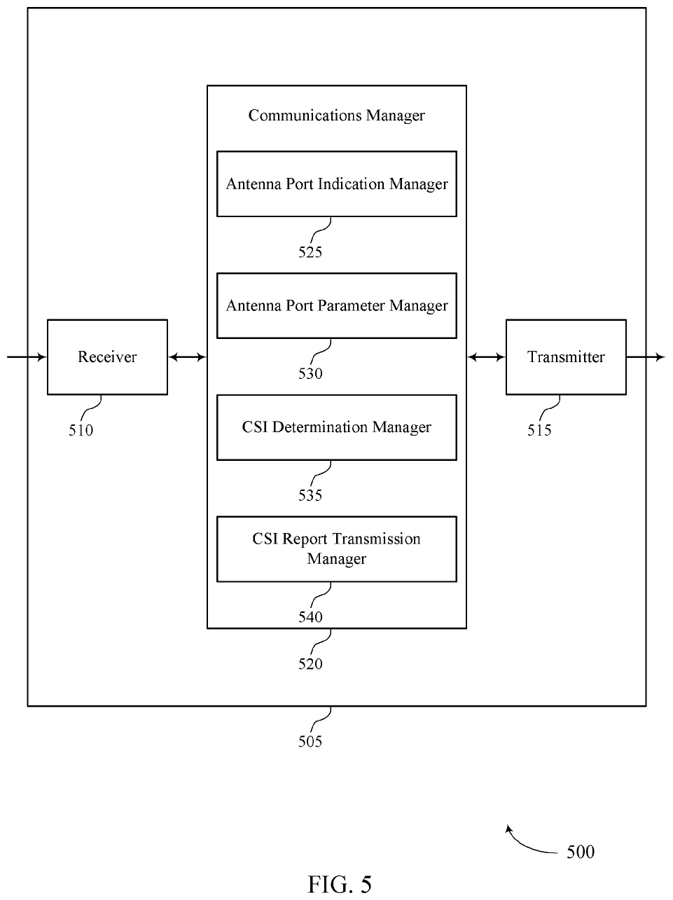

FIG. 5 shows a block diagram 500 of a device 505 that supports techniques for reporting CSI in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for reporting CSI). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for reporting CSI). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for reporting CSI as described herein. For example, the communications manager 520 may include an antenna port indication manager 525, an antenna port parameter manager 530, a CSI determination manager 535, a CSI report transmission manager 540, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, transmit information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. The antenna port indication manager 525 may be configured as or otherwise support a means for receiving a first indication of a first number of antenna ports for which the UE is to report CSI, and a second indication of a second number of antenna ports on which the UE is to measure CSI-RSs, the second number of antenna ports being less than the first number of antenna ports. The antenna port parameter manager 530 may be configured as or otherwise support a means for receiving an additional indication of one or more antenna port parameters, each associated with one of the first number of antenna ports or the second number of antenna ports, the one or more antenna port parameters including either an antenna port pattern or a transfer domain basis. The CSI determination manager 535 may be configured as or otherwise support a means for determining the CSI for the first number of antenna ports using the one or more antenna port parameters and measurements made by the UE on the second number of antenna ports. The CSI report transmission manager 540 may be configured as or otherwise support a means for transmitting a report including the CSI for the first number of antenna ports.

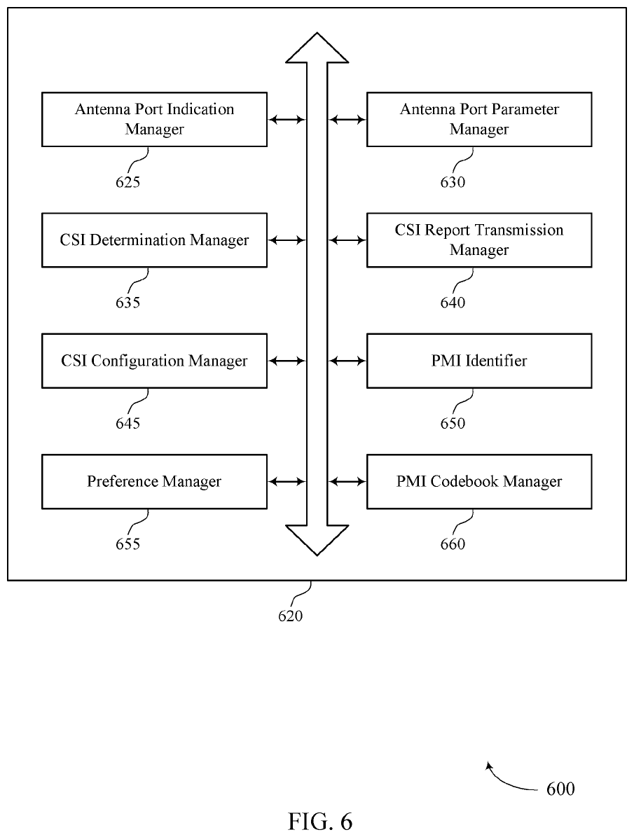

FIG. 6 shows a block diagram 600 of a communications manager 620 that supports techniques for reporting CSI in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for reporting CSI as described herein. For example, the communications manager 620 may include an antenna port indication manager 625, an antenna port parameter manager 630, a CSI determination manager 635, a CSI report transmission manager 640, a CSI configuration manager 645, a PMI identifier 650, a preference manager 655, a PMI codebook manager 660, or any combination thereof. Each of these components may communicate, directly or indirectly, with one another (e.g., via one or more buses).

The communications manager 620 may support wireless communications at a UE in accordance with examples as disclosed herein. The antenna port indication manager 625 may be configured as or otherwise support a means for receiving a first indication of a first number of antenna ports for which the UE is to report CSI, and a second indication of a second number of antenna ports on which the UE is to measure CSI-RSs, the second number of antenna ports being less than the first number of antenna ports. The antenna port parameter manager 630 may be configured as or otherwise support a means for receiving an additional indication of one or more antenna port parameters, each associated with one of the first number of antenna ports or the second number of antenna ports, the one or more antenna port parameters including either an antenna port pattern or a transfer domain basis. The CSI determination manager 635 may be configured as or otherwise support a means for determining the CSI for the first number of antenna ports using the one or more antenna port parameters and measurements made by the UE on the second number of antenna ports. The CSI report transmission manager 640 may be configured as or otherwise support a means for transmitting a report including the CSI for the first number of antenna ports.

In some examples, to support receiving the additional indication of the one or more antenna port parameters, the antenna port parameter manager 630 may be configured as or otherwise support a means for receiving a message indicating a first set of antenna port patterns associated with the first number of antenna ports, and indicating a second set of antenna port patterns associated with the second number of antenna ports, where the second set of antenna port patterns are a subset of the first set of antenna port patterns.

In some examples, to support receiving the message indicating the first set of antenna port patterns and the second set of antenna port patterns, the antenna port parameter manager 630 may be configured as or otherwise support a means for receiving the first set of antenna port patterns and the second set of antenna port patterns as a set of multiple rectangular or linear antenna arrays with inter-antenna distance information.

In some examples, to support receiving the message indicating the first set of antenna port patterns and the second set of antenna port patterns, the antenna port parameter manager 630 may be configured as or otherwise support a means for receiving one or more pattern indications that refer to a set of multiple predefined antenna port patterns.

In some examples, to support receiving the additional indication of the one or more antenna port parameters, the antenna port parameter manager 630 may be configured as or otherwise support a means for receiving a message indicating a first set of transfer domain bases associated with the first number of antenna ports, and indicating a second set of transfer domain bases associated with the second number of antenna ports, where the second set of transfer domain bases are a subset of the first set of transfer domain bases.

In some examples, the CSI configuration manager 645 may be configured as or otherwise support a means for receiving the first indication, the second indication, and the additional indication via at least one of a CSI report configuration or a CSI resource configuration.

In some examples, to support receiving the first indication, the second, indication, and the additional indication, the CSI configuration manager 645 may be configured as or otherwise support a means for receiving, via the CSI report configuration, the first indication and the additional indication, where the additional indication indicates a first antenna port parameter associated with the first number of antenna ports and a second antenna port parameter associated with the second number of antenna ports. In some examples, to support receiving the first indication, the second, indication, and the additional indication, the CSI configuration manager 645 may be configured as or otherwise support a means for receiving, via the CSI resource configuration, the second indication.

In some examples, to support receiving the first indication, the second, indication, and the additional indication, the CSI configuration manager 645 may be configured as or otherwise support a means for receiving, via the CSI report configuration, the second indication and the additional indication, where the additional indication indicates a first antenna port parameter associated with the first number of antenna ports and a second antenna port parameter associated with the second number of antenna ports. In some examples, to support receiving the first indication, the second, indication, and the additional indication, the CSI configuration manager 645 may be configured as or otherwise support a means for receiving, via the CSI resource configuration, the first indication.

In some examples, the CSI configuration manager 645 may be configured as or otherwise support a means for receiving, via a codebook configuration within the CSI report configuration, one or more codebook types that are based on the first indication, the second indication, and the additional indication, where the additional indication indicates at least a first antenna port parameter associated with the second number of antenna ports.

In some examples, to support receiving the first indication, the second, indication, and the additional indication, the CSI configuration manager 645 may be configured as or otherwise support a means for receiving, via the CSI resource configuration, the first indication, the second indication, and the additional indication, where the additional indication indicates a first antenna port parameter associated with the first number of antenna ports and a second antenna port parameter associated with the second number of antenna ports.

In some examples, to support determining the CSI, the PMI identifier 650 may be configured as or otherwise support a means for identifying one or more PMIs for the first number of antenna ports using the one or more antenna port parameters and measurements made by the UE on the second number of antenna ports.

In some examples, the PMI codebook manager 660 may be configured as or otherwise support a means for receiving a message indicating a precoding matrix codebook including a set of multiple PMIs, where the one or more PMIs are identified from the precoding matrix codebook.

In some examples, to support receiving the message indicating the precoding matrix codebook, the PMI codebook manager 660 may be configured as or otherwise support a means for receiving a CSI report configuration, the CSI report configuration including the precoding matrix codebook.

In some examples, each PMI of the set of multiple PMIs is based on the first number of antenna ports, the second number of antenna ports, the one or more antenna port parameters, or a combination thereof.

In some examples, the preference manager 655 may be configured as or otherwise support a means for transmitting a signal indicating a preference of the UE for selecting the second number of antenna ports, where receiving the second indication of the second number of antenna ports is based on transmitting the signal indicating the preference.

In some examples, the preference includes a value of second number of antenna ports, an antenna port pattern associated with the second number of antenna ports, or a transfer domain basis associated with the second number of antenna ports, or a combination thereof.

In some examples, the signal indicating the preference is transmitted in an RRC message, a MAC-CE message, or a UCI message.

In some examples, the UE receives the first indication, the second indication, and the additional indication in a same message. In some examples, the UE receives the first indication and the additional indication in a same message. In some examples, the UE receives the second indication and the additional indication in a same message. In some examples, the second number of antenna ports is a subset of the first number of antenna ports.

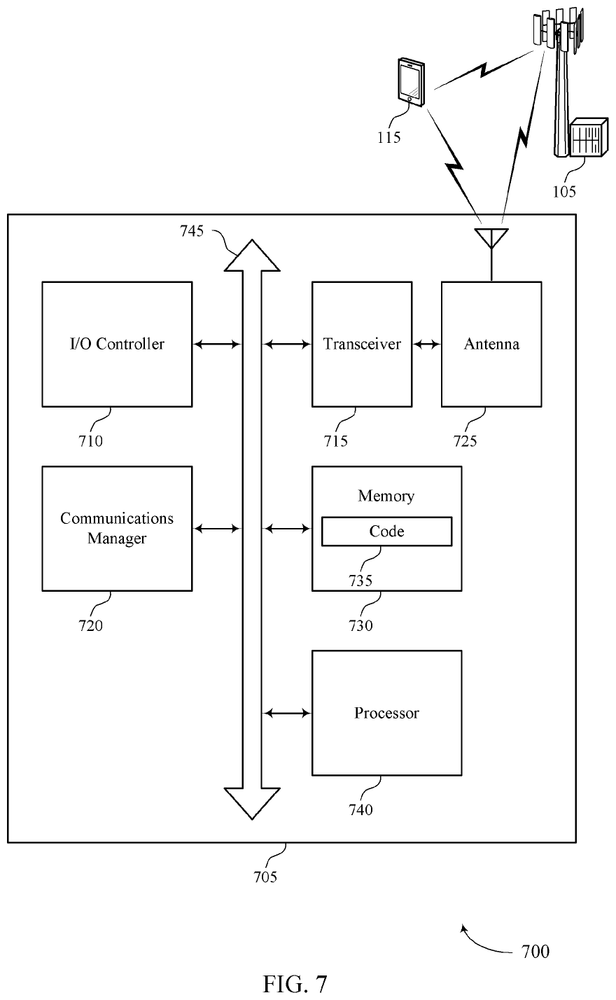

FIG. 7 shows a diagram of a system 700 including a device 705 that supports techniques for reporting CSI in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for reporting CSI). For example, the device 705 or a component of the device 705 may include a processor 740 and memory 730 coupled to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving a first indication of a first number of antenna ports for which the UE is to report CSI, and a second indication of a second number of antenna ports on which the UE is to measure CSI-RSs, the second number of antenna ports being less than the first number of antenna ports. The communications manager 720 may be configured as or otherwise support a means for receiving an additional indication of one or more antenna port parameters, each associated with one of the first number of antenna ports or the second number of antenna ports, the one or more antenna port parameters including either an antenna port pattern or a transfer domain basis. The communications manager 720 may be configured as or otherwise support a means for determining the CSI for the first number of antenna ports using the one or more antenna port parameters and measurements made by the UE on the second number of antenna ports. The communications manager 720 may be configured as or otherwise support a means for transmitting a report including the CSI for the first number of antenna ports.

By including or configuring the communications manager 720 in accordance with examples as described herein, the device 705 may support techniques for reduced CSI-RS overhead, improved communication reliability, reduced latency, improved user experience related to reduced processing, reduced power consumption, more efficient utilization of communication resources, improved coordination between devices, longer battery life, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for reporting CSI as described herein, or the processor 740 and the memory 730 may be otherwise configured to perform or support such operations.

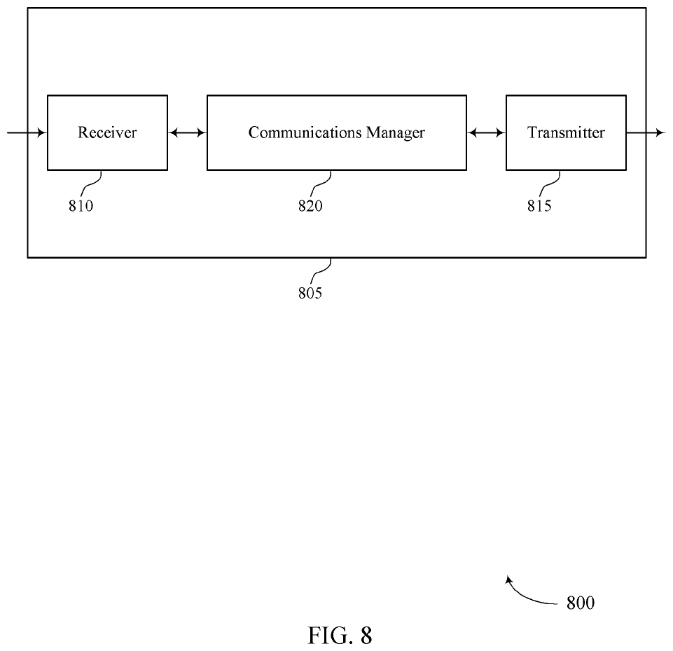

FIG. 8 shows a block diagram 800 of a device 805 that supports techniques for reporting CSI in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for reporting CSI). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for reporting CSI). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for reporting CSI as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, transmit information to the transmitter 815, or be integrated in combination with the receiver 810, the transmitter 815, or both to receive information, transmit information, or perform various other operations as described herein.

The communications manager 820 may support wireless communications at a base station in accordance with examples as disclosed herein. For example, the communications manager 820 may be configured as or otherwise support a means for transmitting a first indication of a first number of antenna ports for which a UE is to report CSI, and a second indication of a second number of antenna ports on which the UE is to measure CSI-RSs, the second number of antenna ports being less than the first number of antenna ports. The communications manager 820 may be configured as or otherwise support a means for transmitting an additional indication of one or more antenna port parameters, each associated with one of the first number of antenna ports or the second number of antenna ports, the one or more antenna port parameters including either an antenna port pattern or a transfer domain basis. The communications manager 820 may be configured as or otherwise support a means for receiving a report including the CSI for the first number of antenna ports, the CSI based on the one or more antenna port parameters and measurements made by the UE on the second number of antenna ports.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced CSI-RS overhead, reduced processing, reduced power consumption, and more efficient utilization of communication resources.

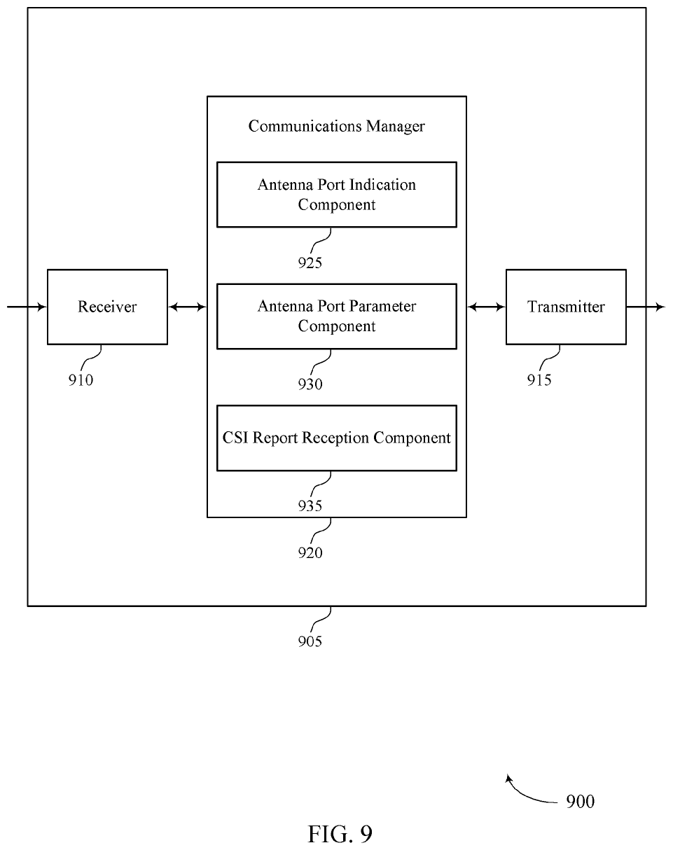

FIG. 9 shows a block diagram 900 of a device 905 that supports techniques for reporting CSI in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for reporting CSI). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for reporting CSI). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for reporting CSI as described herein. For example, the communications manager 920 may include an antenna port indication component 925, an antenna port parameter component 930, a CSI report reception component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, transmit information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. The antenna port indication component 925 may be configured as or otherwise support a means for transmitting a first indication of a first number of antenna ports for which a UE is to report CSI, and a second indication of a second number of antenna ports on which the UE is to measure CSI-RSs, the second number of antenna ports being less than the first number of antenna ports. The antenna port parameter component 930 may be configured as or otherwise support a means for transmitting an additional indication of one or more antenna port parameters, each associated with one of the first number of antenna ports or the second number of antenna ports, the one or more antenna port parameters including either an antenna port pattern or a transfer domain basis. The CSI report reception component 935 may be configured as or otherwise support a means for receiving a report including the CSI for the first number of antenna ports, the CSI based on the one or more antenna port parameters and measurements made by the UE on the second number of antenna ports.

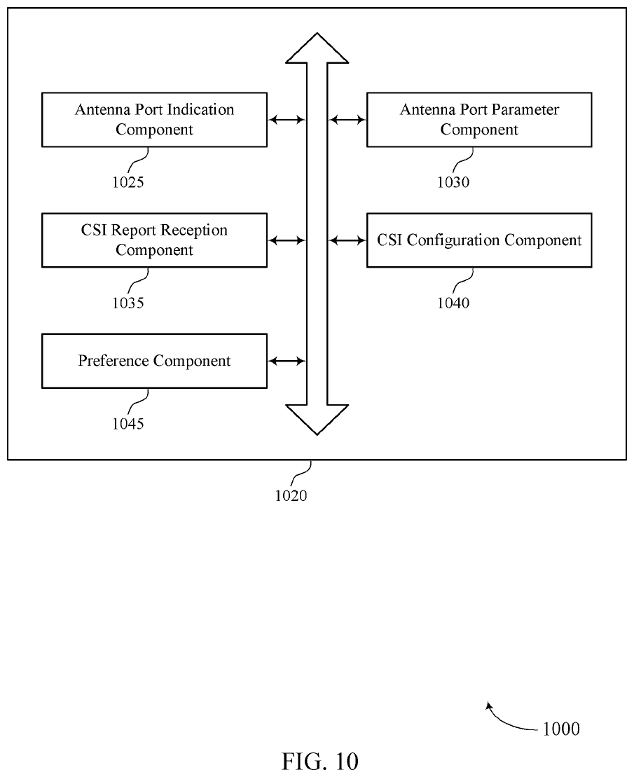

FIG. 10 shows a block diagram 1000 of a communications manager 1020 that supports techniques for reporting CSI in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for reporting CSI as described herein. For example, the communications manager 1020 may include an antenna port indication component 1025, an antenna port parameter component 1030, a CSI report reception component 1035, a CSI configuration component 1040, a preference component 1045, or any combination thereof. Each of these components may communicate, directly or indirectly, with one another (e.g., via one or more buses).

The communications manager 1020 may support wireless communications at a base station in accordance with examples as disclosed herein. The antenna port indication component 1025 may be configured as or otherwise support a means for transmitting a first indication of a first number of antenna ports for which a UE is to report CSI, and a second indication of a second number of antenna ports on which the UE is to measure CSI-RSs, the second number of antenna ports being less than the first number of antenna ports. The antenna port parameter component 1030 may be configured as or otherwise support a means for transmitting an additional indication of one or more antenna port parameters, each associated with one of the first number of antenna ports or the second number of antenna ports, the one or more antenna port parameters including either an antenna port pattern or a transfer domain basis. The CSI report reception component 1035 may be configured as or otherwise support a means for receiving a report including the CSI for the first number of antenna ports, the CSI based on the one or more antenna port parameters and measurements made by the UE on the second number of antenna ports.

In some examples, to support transmitting the additional indication of the one or more antenna port parameters, the antenna port parameter component 1030 may be configured as or otherwise support a means for transmitting a message indicating a first set of antenna port patterns associated with the first number of antenna ports, and indicating a second set of antenna port patterns associated with the second number of antenna ports, where the second set of antenna port patterns are a subset of the first set of antenna port patterns.

In some examples, to support transmitting the message indicating the first set of antenna port patterns and the second set of antenna port patterns, the antenna port parameter component 1030 may be configured as or otherwise support a means for transmitting the first set of antenna port patterns and the second set of antenna port patterns as a set of multiple rectangular or linear antenna arrays with inter-antenna distance information.

In some examples, to support transmitting the message indicating the first set of antenna port patterns and the second set of antenna port patterns, the antenna port parameter component 1030 may be configured as or otherwise support a means for transmitting one or more pattern indications that refer to a set of multiple predefined antenna port patterns.

In some examples, to support transmitting the additional indication of the one or more antenna port parameters, the antenna port parameter component 1030 may be configured as or otherwise support a means for transmitting a message indicating a first set of transfer domain basis associated with the first number of antenna ports, and indicating a second set of transfer domain basis associated with the second number of antenna ports, where the second set of transfer domain basis are a subset of the first set of transfer domain basis.

In some examples, the CSI configuration component 1040 may be configured as or otherwise support a means for transmitting the first indication, the second indication, and the additional indication via at least one of a CSI report configuration or a CSI resource configuration.

In some examples, to support transmitting the first indication, the second, indication, and the additional indication, the CSI configuration component 1040 may be configured as or otherwise support a means for transmitting, via the CSI report configuration, the first indication and the additional indication, where the additional indication indicates a first antenna port parameter associated with the first number of antenna ports and a second antenna port parameter associated with the second number of antenna ports. In some examples, to support transmitting the first indication, the second, indication, and the additional indication, the CSI configuration component 1040 may be configured as or otherwise support a means for transmitting, via the CSI resource configuration, the second indication.

In some examples, to support transmitting the first indication, the second, indication, and the additional indication, the CSI configuration component 1040 may be configured as or otherwise support a means for transmitting, via the CSI report configuration, the second indication and the additional indication, where the additional indication indicates a first antenna port parameter associated with the first number of antenna ports and a second antenna port parameter associated with the second number of antenna ports. In some examples, to support transmitting the first indication, the second, indication, and the additional indication, the CSI configuration component 1040 may be configured as or otherwise support a means for transmitting, via the CSI resource configuration, the first indication.

In some examples, the CSI configuration component 1040 may be configured as or otherwise support a means for transmitting, via a codebook configuration within the CSI report configuration, one or more codebook types that are based on the first indication, the second indication, and the additional indication, where the additional indication indicates at least a first antenna port parameter associated with the second number of antenna ports.

In some examples, to support transmitting the first indication, the second, indication, and the additional indication, the CSI configuration component 1040 may be configured as or otherwise support a means for transmitting, via the CSI resource configuration, the first indication, the second indication, and the additional indication, where the additional indication indicates a first antenna port parameter associated with the first number of antenna ports and a second antenna port parameter associated with the second number of antenna ports.

In some examples, the CSI configuration component 1040 may be configured as or otherwise support a means for transmitting a CSI report configuration message indicating a precoding matrix codebook including a set of multiple PMIs, where each PMI of the set of multiple PMIs is based on the first number of antenna ports, the second number of antenna ports, or the one or more antenna port parameters, or a combination thereof.

In some examples, the preference component 1045 may be configured as or otherwise support a means for receiving a signal indicating a preference of the UE for selecting the second number of antenna ports, the preference including a value of second number of antenna ports, an antenna port pattern associated with the second number of antenna ports, or a transfer domain basis associated with the second number of antenna ports, or a combination thereof, where transmitting the second indication of the second number of antenna ports is based on transmitting the signal indicating the preference.

In some examples, to support transmitting the additional indication of the one or more antenna port parameters, the antenna port parameter component 1030 may be configured as or otherwise support a means for transmitting a message indicating a first set of antenna port patterns associated with the first number of antenna ports, and indicating a second set of antenna port patterns associated with the second number of antenna ports, where the second set of antenna port patterns are a subset of the first set of antenna port patterns.

In some examples, to support transmitting the additional indication of the one or more antenna port parameters, the antenna port parameter component 1030 may be configured as or otherwise support a means for transmitting a message indicating a first set of transfer domain basis associated with the first number of antenna ports, and indicating a second set of transfer domain basis associated with the second number of antenna ports, where the second set of transfer domain basis are a subset of the first set of transfer domain basis.

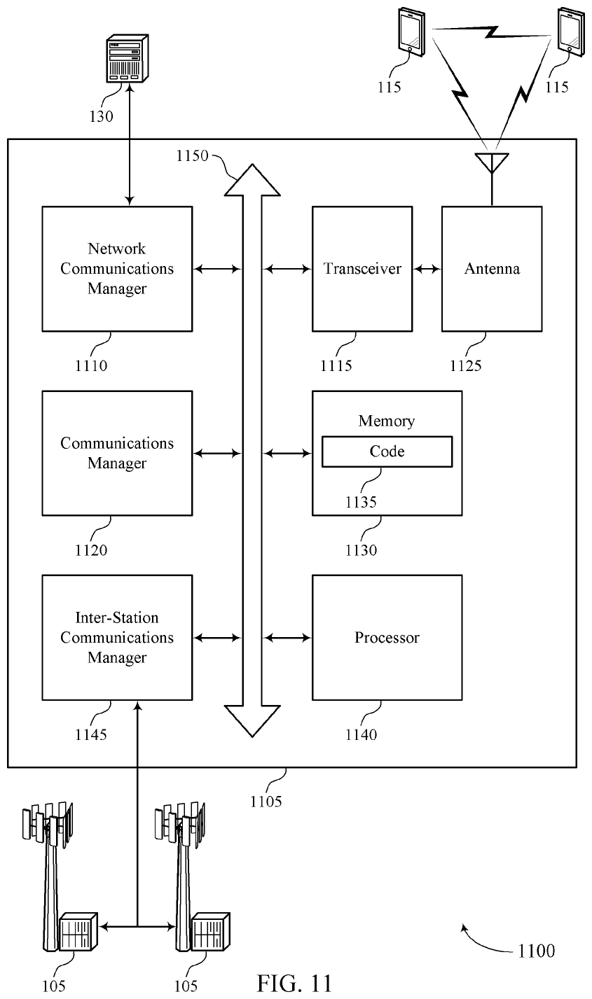

FIG. 11 shows a diagram of a system 1100 including a device 1105 that supports techniques for reporting CSI in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for reporting CSI). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communications at a base station in accordance with examples as disclosed herein. For example, the communications manager 1120 may be configured as or otherwise support a means for transmitting a first indication of a first number of antenna ports for which a UE is to report CSI, and a second indication of a second number of antenna ports on which the UE is to measure CSI-RSs, the second number of antenna ports being less than the first number of antenna ports. The communications manager 1120 may be configured as or otherwise support a means for transmitting an additional indication of one or more antenna port parameters, each associated with one of the first number of antenna ports or the second number of antenna ports, the one or more antenna port parameters including either an antenna port pattern or a transfer domain basis. The communications manager 1120 may be configured as or otherwise support a means for receiving a report including the CSI for the first number of antenna ports, the CSI based on the one or more antenna port parameters and measurements made by the UE on the second number of antenna ports.

By including or configuring the communications manager 1120 in accordance with examples as described herein, the device 1105 may support techniques for reduced CSI-RS overhead, improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for reporting CSI as described herein, or the processor 1140 and the memory 1130 may be otherwise configured to perform or support such operations.

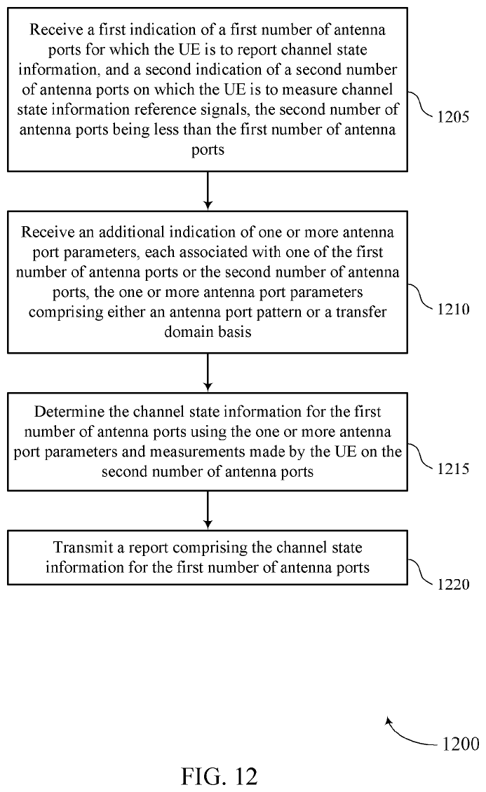

FIG. 12 shows a flowchart illustrating a method 1200 that supports techniques for reporting CSI in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving a first indication of a first number of antenna ports for which the UE is to report CSI, and a second indication of a second number of antenna ports on which the UE is to measure CSI-RSs, the second number of antenna ports being less than the first number of antenna ports. The operations of 1205 may be performed in accordance with examples as disclosed herein. In some examples, aspects of the operations of 1205 may be performed by an antenna port indication manager 625 as described with reference to FIG. 6.

At 1210, the method may include receiving an additional indication of one or more antenna port parameters, each associated with one of the first number of antenna ports or the second number of antenna ports, the one or more antenna port parameters including either an antenna port pattern or a transfer domain basis. The operations of 1210 may be performed in accordance with examples as disclosed herein. In some examples, aspects of the operations of 1210 may be performed by an antenna port parameter manager 630 as described with reference to FIG. 6.

At 1215, the method may include determining the CSI for the first number of antenna ports using the one or more antenna port parameters and measurements made by the UE on the second number of antenna ports. The operations of 1215 may be performed in accordance with examples as disclosed herein. In some examples, aspects of the operations of 1215 may be performed by a CSI determination manager 635 as described with reference to FIG. 6.

At 1220, the method may include transmitting a report including the CSI for the first number of antenna ports. The operations of 1220 may be performed in accordance with examples as disclosed herein. In some examples, aspects of the operations of 1220 may be performed by a CSI report transmission manager 640 as described with reference to FIG. 6.

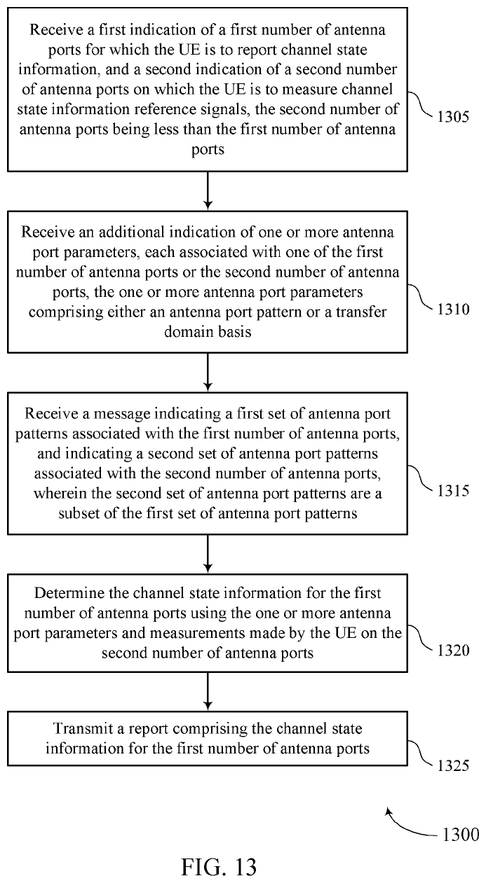

FIG. 13 shows a flowchart illustrating a method 1300 that supports techniques for reporting CSI in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include receiving a first indication of a first number of antenna ports for which the UE is to report CSI, and a second indication of a second number of antenna ports on which the UE is to measure CSI-RSs, the second number of antenna ports being less than the first number of antenna ports. The operations of 1305 may be performed in accordance with examples as disclosed herein. In some examples, aspects of the operations of 1305 may be performed by an antenna port indication manager 625 as described with reference to FIG. 6.

At 1310, the method may include receiving an additional indication of one or more antenna port parameters, each associated with one of the first number of antenna ports or the second number of antenna ports, the one or more antenna port parameters including either an antenna port pattern or a transfer domain basis. The operations of 1310 may be performed in accordance with examples as disclosed herein. In some examples, aspects of the operations of 1310 may be performed by an antenna port parameter manager 630 as described with reference to FIG. 6.

At 1315, the method may include receiving a message indicating a first set of antenna port patterns associated with the first number of antenna ports, and indicating a second set of antenna port patterns associated with the second number of antenna ports, where the second set of antenna port patterns are a subset of the first set of antenna port patterns. The operations of 1315 may be performed in accordance with examples as disclosed herein. In some examples, aspects of the operations of 1315 may be performed by an antenna port parameter manager 630 as described with reference to FIG. 6.

At 1320, the method may include determining the CSI for the first number of antenna ports using the one or more antenna port parameters and measurements made by the UE on the second number of antenna ports. The operations of 1320 may be performed in accordance with examples as disclosed herein. In some examples, aspects of the operations of 1320 may be performed by a CSI determination manager 635 as described with reference to FIG. 6.

At 1325, the method may include transmitting a report including the CSI for the first number of antenna ports. The operations of 1325 may be performed in accordance with examples as disclosed herein. In some examples, aspects of the operations of 1325 may be performed by a CSI report transmission manager 640 as described with reference to FIG. 6.

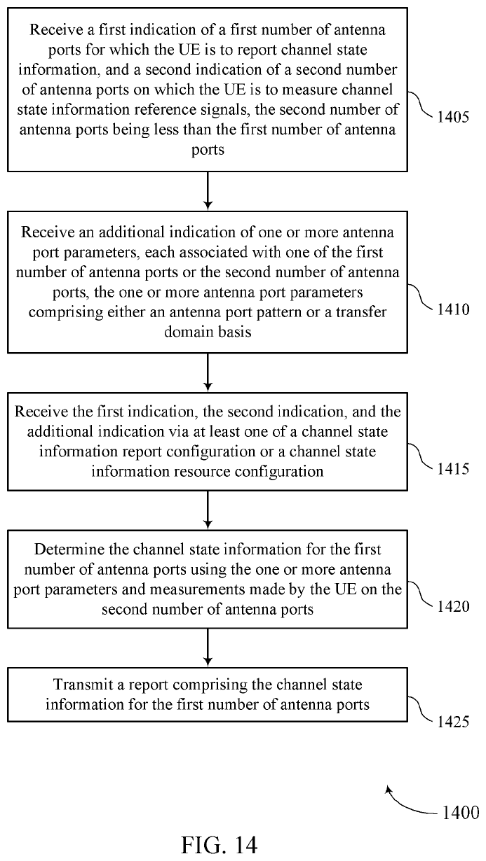

FIG. 14 shows a flowchart illustrating a method 1400 that supports techniques for reporting CSI in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1405, the method may include receiving a first indication of a first number of antenna ports for which the UE is to report CSI, and a second indication of a second number of antenna ports on which the UE is to measure CSI-RSs, the second number of antenna ports being less than the first number of antenna ports. The operations of 1405 may be performed in accordance with examples as disclosed herein. In some examples, aspects of the operations of 1405 may be performed by an antenna port indication manager 625 as described with reference to FIG. 6.

At 1410, the method may include receiving an additional indication of one or more antenna port parameters, each associated with one of the first number of antenna ports or the second number of antenna ports, the one or more antenna port parameters including either an antenna port pattern or a transfer domain basis. The operations of 1410 may be performed in accordance with examples as disclosed herein. In some examples, aspects of the operations of 1410 may be performed by an antenna port parameter manager 630 as described with reference to FIG. 6.

At 1415, the method may include receiving the first indication, the second indication, and the additional indication via at least one of a CSI report configuration or a CSI resource configuration. The operations of 1415 may be performed in accordance with examples as disclosed herein. In some examples, aspects of the operations of 1415 may be performed by a CSI configuration manager 645 as described with reference to FIG. 6.

At 1420, the method may include determining the CSI for the first number of antenna ports using the one or more antenna port parameters and measurements made by the UE on the second number of antenna ports. The operations of 1420 may be performed in accordance with examples as disclosed herein. In some examples, aspects of the operations of 1420 may be performed by a CSI determination manager 635 as described with reference to FIG. 6.

At 1425, the method may include transmitting a report including the CSI for the first number of antenna ports. The operations of 1425 may be performed in accordance with examples as disclosed herein. In some examples, aspects of the operations of 1425 may be performed by a CSI report transmission manager 640 as described with reference to FIG. 6.

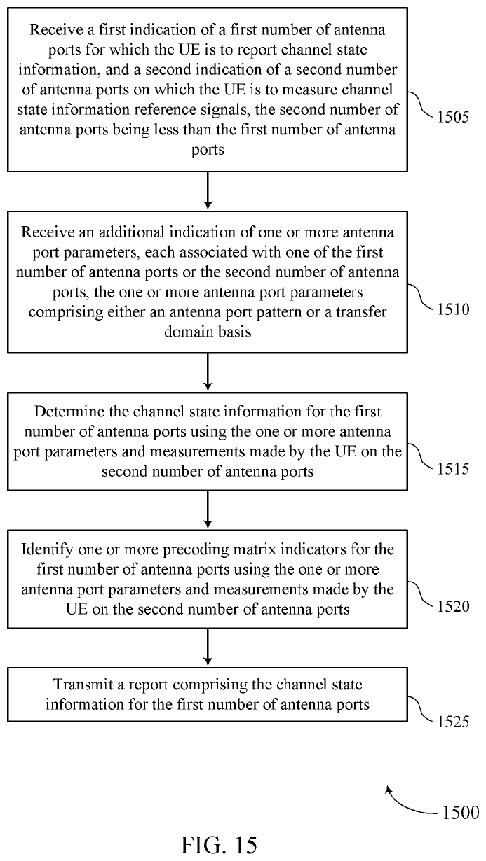

FIG. 15 shows a flowchart illustrating a method 1500 that supports techniques for reporting CSI in accordance with aspects of the present disclosure. The operations of the method 1500 may be implemented by a UE or its components as described herein. For example, the operations of the method 1500 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1505, the method may include receiving a first indication of a first number of antenna ports for which the UE is to report CSI, and a second indication of a second number of antenna ports on which the UE is to measure CSI-RSs, the second number of antenna ports being less than the first number of antenna ports. The operations of 1505 may be performed in accordance with examples as disclosed herein. In some examples, aspects of the operations of 1505 may be performed by an antenna port indication manager 625 as described with reference to FIG. 6.

At 1510, the method may include receiving an additional indication of one or more antenna port parameters, each associated with one of the first number of antenna ports or the second number of antenna ports, the one or more antenna port parameters including either an antenna port pattern or a transfer domain basis. The operations of 1510 may be performed in accordance with examples as disclosed herein. In some examples, aspects of the operations of 1510 may be performed by an antenna port parameter manager 630 as described with reference to FIG. 6.

At 1515, the method may include determining the CSI for the first number of antenna ports using the one or more antenna port parameters and measurements made by the UE on the second number of antenna ports. The operations of 1515 may be performed in accordance with examples as disclosed herein. In some examples, aspects of the operations of 1515 may be performed by a CSI determination manager 635 as described with reference to FIG. 6.

At 1520, the method may include identifying one or more PMIs for the first number of antenna ports using the one or more antenna port parameters and measurements made by the UE on the second number of antenna ports. The operations of 1520 may be performed in accordance with examples as disclosed herein. In some examples, aspects of the operations of 1520 may be performed by a PMI identifier 650 as described with reference to FIG. 6.

At 1525, the method may include transmitting a report including the CSI for the first number of antenna ports. The operations of 1525 may be performed in accordance with examples as disclosed herein. In some examples, aspects of the operations of 1525 may be performed by a CSI report transmission manager 640 as described with reference to FIG. 6.

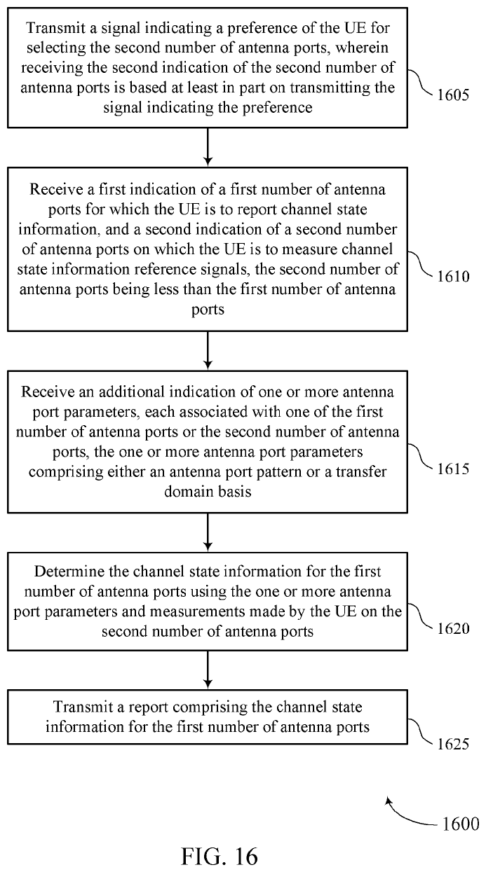

FIG. 16 shows a flowchart illustrating a method 1600 that supports techniques for reporting CSI in accordance with aspects of the present disclosure. The operations of the method 1600 may be implemented by a UE or its components as described herein. For example, the operations of the method 1600 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1605, the method may include transmitting a signal indicating a preference of the UE for selecting the second number of antenna ports, where receiving the second indication of the second number of antenna ports is based on transmitting the signal indicating the preference. The operations of 1605 may be performed in accordance with examples as disclosed herein. In some examples, aspects of the operations of 1605 may be performed by a preference manager 655 as described with reference to FIG. 6.

At 1610, the method may include receiving a first indication of a first number of antenna ports for which the UE is to report CSI, and a second indication of a second number of antenna ports on which the UE is to measure CSI-RSs, the second number of antenna ports being less than the first number of antenna ports. The operations of 1610 may be performed in accordance with examples as disclosed herein. In some examples, aspects of the operations of 1610 may be performed by an antenna port indication manager 625 as described with reference to FIG. 6.

At 1615, the method may include receiving an additional indication of one or more antenna port parameters, each associated with one of the first number of antenna ports or the second number of antenna ports, the one or more antenna port parameters including either an antenna port pattern or a transfer domain basis. The operations of 1615 may be performed in accordance with examples as disclosed herein. In some examples, aspects of the operations of 1615 may be performed by an antenna port parameter manager 630 as described with reference to FIG. 6.

At 1620, the method may include determining the CSI for the first number of antenna ports using the one or more antenna port parameters and measurements made by the UE on the second number of antenna ports. The operations of 1620 may be performed in accordance with examples as disclosed herein. In some examples, aspects of the operations of 1620 may be performed by a CSI determination manager 635 as described with reference to FIG. 6.

At 1625, the method may include transmitting a report including the CSI for the first number of antenna ports. The operations of 1625 may be performed in accordance with examples as disclosed herein. In some examples, aspects of the operations of 1625 may be performed by a CSI report transmission manager 640 as described with reference to FIG. 6.

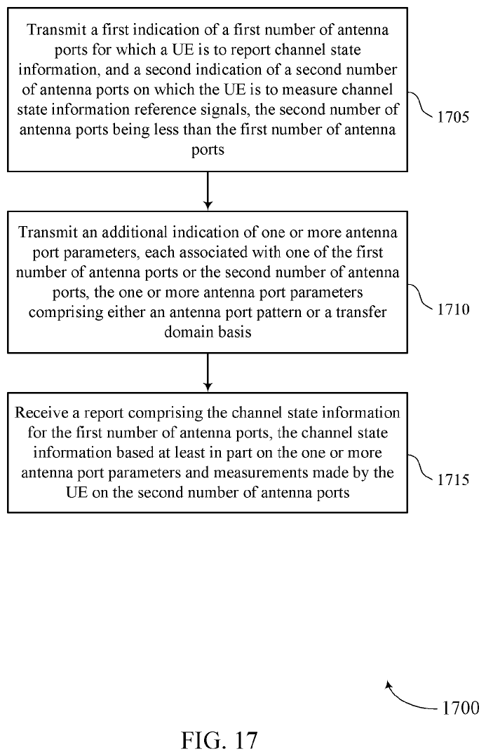

FIG. 17 shows a flowchart illustrating a method 1700 that supports techniques for reporting CSI in accordance with aspects of the present disclosure. The operations of the method 1700 may be implemented by a base station or its components as described herein. For example, the operations of the method 1700 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1705, the method may include transmitting a first indication of a first number of antenna ports for which a UE is to report CSI, and a second indication of a second number of antenna ports on which the UE is to measure CSI-RSs, the second number of antenna ports being less than the first number of antenna ports. The operations of 1705 may be performed in accordance with examples as disclosed herein. In some examples, aspects of the operations of 1705 may be performed by an antenna port indication component 1025 as described with reference to FIG. 10.

At 1710, the method may include transmitting an additional indication of one or more antenna port parameters, each associated with one of the first number of antenna ports or the second number of antenna ports, the one or more antenna port parameters including either an antenna port pattern or a transfer domain basis. The operations of 1710 may be performed in accordance with examples as disclosed herein. In some examples, aspects of the operations of 1710 may be performed by an antenna port parameter component 1030 as described with reference to FIG. 10.

At 1715, the method may include receiving a report including the CSI for the first number of antenna ports, the CSI based on the one or more antenna port parameters and measurements made by the UE on the second number of antenna ports. The operations of 1715 may be performed in accordance with examples as disclosed herein. In some examples, aspects of the operations of 1715 may be performed by a CSI report reception component 1035 as described with reference to FIG. 10.

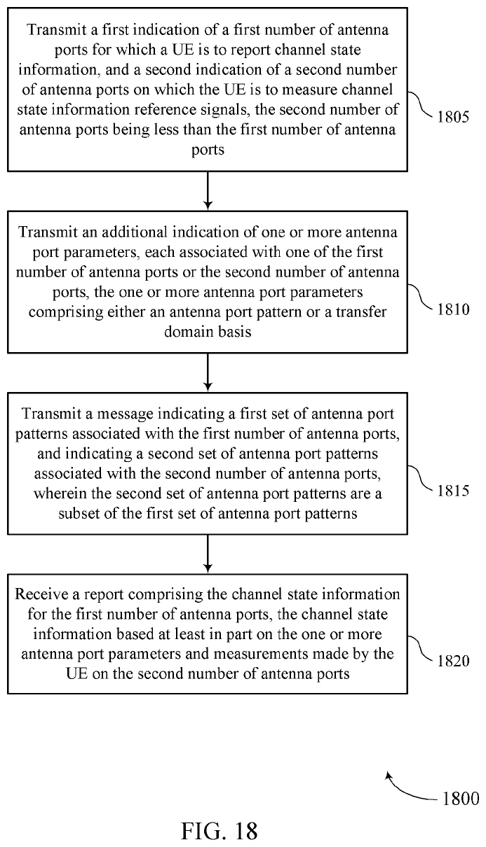

FIG. 18 shows a flowchart illustrating a method 1800 that supports techniques for reporting CSI in accordance with aspects of the present disclosure. The operations of the method 1800 may be implemented by a base station or its components as described herein. For example, the operations of the method 1800 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1805, the method may include transmitting a first indication of a first number of antenna ports for which a UE is to report CSI, and a second indication of a second number of antenna ports on which the UE is to measure CSI-RSs, the second number of antenna ports being less than the first number of antenna ports. The operations of 1805 may be performed in accordance with examples as disclosed herein. In some examples, aspects of the operations of 1805 may be performed by an antenna port indication component 1025 as described with reference to FIG. 10.

At 1810, the method may include transmitting an additional indication of one or more antenna port parameters, each associated with one of the first number of antenna ports or the second number of antenna ports, the one or more antenna port parameters including either an antenna port pattern or a transfer domain basis. The operations of 1810 may be performed in accordance with examples as disclosed herein. In some examples, aspects of the operations of 1810 may be performed by an antenna port parameter component 1030 as described with reference to FIG. 10.

At 1815, the method may include transmitting a message indicating a first set of antenna port patterns associated with the first number of antenna ports, and indicating a second set of antenna port patterns associated with the second number of antenna ports, where the second set of antenna port patterns are a subset of the first set of antenna port patterns. The operations of 1815 may be performed in accordance with examples as disclosed herein. In some examples, aspects of the operations of 1815 may be performed by an antenna port parameter component 1030 as described with reference to FIG. 10.

At 1820, the method may include receiving a report including the CSI for the first number of antenna ports, the CSI based on the one or more antenna port parameters and measurements made by the UE on the second number of antenna ports. The operations of 1820 may be performed in accordance with examples as disclosed herein. In some examples, aspects of the operations of 1820 may be performed by a CSI report reception component 1035 as described with reference to FIG. 10.

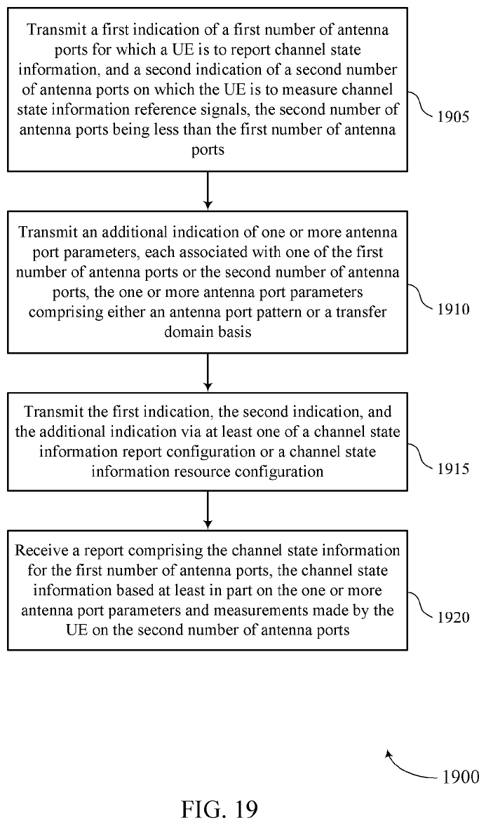

FIG. 19 shows a flowchart illustrating a method 1900 that supports techniques for reporting CSI in accordance with aspects of the present disclosure. The operations of the method 1900 may be implemented by a base station or its components as described herein. For example, the operations of the method 1900 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1905, the method may include transmitting a first indication of a first number of antenna ports for which a UE is to report CSI, and a second indication of a second number of antenna ports on which the UE is to measure CSI-RSs, the second number of antenna ports being less than the first number of antenna ports. The operations of 1905 may be performed in accordance with examples as disclosed herein. In some examples, aspects of the operations of 1905 may be performed by an antenna port indication component 1025 as described with reference to FIG. 10.

At 1910, the method may include transmitting an additional indication of one or more antenna port parameters, each associated with one of the first number of antenna ports or the second number of antenna ports, the one or more antenna port parameters including either an antenna port pattern or a transfer domain basis. The operations of 1910 may be performed in accordance with examples as disclosed herein. In some examples, aspects of the operations of 1910 may be performed by an antenna port parameter component 1030 as described with reference to FIG. 10.

At 1915, the method may include transmitting the first indication, the second indication, and the additional indication via at least one of a CSI report configuration or a CSI resource configuration. The operations of 1915 may be performed in accordance with examples as disclosed herein. In some examples, aspects of the operations of 1915 may be performed by a CSI configuration component 1040 as described with reference to FIG. 10.

At 1920, the method may include receiving a report including the CSI for the first number of antenna ports, the CSI based on the one or more antenna port parameters and measurements made by the UE on the second number of antenna ports. The operations of 1920 may be performed in accordance with examples as disclosed herein. In some examples, aspects of the operations of 1920 may be performed by a CSI report reception component 1035 as described with reference to FIG. 10.

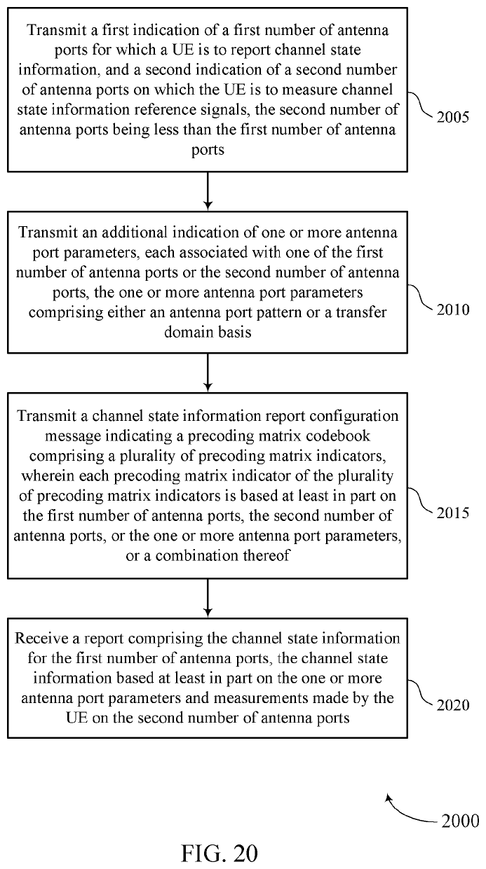

FIG. 20 shows a flowchart illustrating a method 2000 that supports techniques for reporting CSI in accordance with aspects of the present disclosure. The operations of the method 2000 may be implemented by a base station or its components as described herein. For example, the operations of the method 2000 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 2005, the method may include transmitting a first indication of a first number of antenna ports for which a UE is to report CSI, and a second indication of a second number of antenna ports on which the UE is to measure CSI-RSs, the second number of antenna ports being less than the first number of antenna ports. The operations of 2005 may be performed in accordance with examples as disclosed herein. In some examples, aspects of the operations of 2005 may be performed by an antenna port indication component 1025 as described with reference to FIG. 10.

At 2010, the method may include transmitting an additional indication of one or more antenna port parameters, each associated with one of the first number of antenna ports or the second number of antenna ports, the one or more antenna port parameters including either an antenna port pattern or a transfer domain basis. The operations of 2010 may be performed in accordance with examples as disclosed herein. In some examples, aspects of the operations of 2010 may be performed by an antenna port parameter component 1030 as described with reference to FIG. 10.

At 2015, the method may include transmitting a CSI report configuration message indicating a precoding matrix codebook including a set of multiple PMIs, where each PMI of the set of multiple PMIs is based on the first number of antenna ports, the second number of antenna ports, or the one or more antenna port parameters, or a combination thereof. The operations of 2015 may be performed in accordance with examples as disclosed herein. In some examples, aspects of the operations of 2015 may be performed by a CSI configuration component 1040 as described with reference to FIG. 10.

At 2020, the method may include receiving a report including the CSI for the first number of antenna ports, the CSI based on the one or more antenna port parameters and measurements made by the UE on the second number of antenna ports. The operations of 2020 may be performed in accordance with examples as disclosed herein. In some examples, aspects of the operations of 2020 may be performed by a CSI report reception component 1035 as described with reference to FIG. 10.

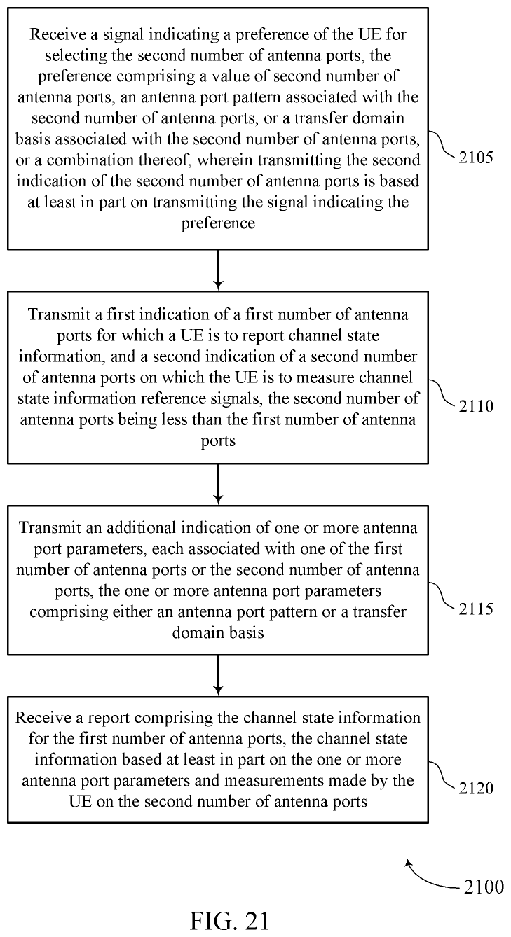

FIG. 21 shows a flowchart illustrating a method 2100 that supports techniques for reporting CSI in accordance with aspects of the present disclosure. The operations of the method 2100 may be implemented by a base station or its components as described herein. For example, the operations of the method 2100 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 2105, the method may include receiving a signal indicating a preference of the UE for selecting the second number of antenna ports, the preference including a value of second number of antenna ports, an antenna port pattern associated with the second number of antenna ports, or a transfer domain basis associated with the second number of antenna ports, or a combination thereof, where transmitting the second indication of the second number of antenna ports is based on transmitting the signal indicating the preference. The operations of 2105 may be performed in accordance with examples as disclosed herein. In some examples, aspects of the operations of 2105 may be performed by a preference component 1045 as described with reference to FIG. 10.

At 2110, the method may include transmitting a first indication of a first number of antenna ports for which a UE is to report CSI, and a second indication of a second number of antenna ports on which the UE is to measure CSI-RSs, the second number of antenna ports being less than the first number of antenna ports. The operations of 2110 may be performed in accordance with examples as disclosed herein. In some examples, aspects of the operations of 2110 may be performed by an antenna port indication component 1025 as described with reference to FIG. 10.

At 2115, the method may include transmitting an additional indication of one or more antenna port parameters, each associated with one of the first number of antenna ports or the second number of antenna ports, the one or more antenna port parameters including either an antenna port pattern or a transfer domain basis. The operations of 2115 may be performed in accordance with examples as disclosed herein. In some examples, aspects of the operations of 2115 may be performed by an antenna port parameter component 1030 as described with reference to FIG. 10.

At 2120, the method may include receiving a report including the CSI for the first number of antenna ports, the CSI based on the one or more antenna port parameters and measurements made by the UE on the second number of antenna ports. The operations of 2120 may be performed in accordance with examples as disclosed herein. In some examples, aspects of the operations of 2120 may be performed by a CSI report reception component 1035 as described with reference to FIG. 10.

The following provides an overview of aspects of the present disclosure:
Aspect 1: A method for wireless communications at a UE, comprising: receiving a first indication of a first number of antenna ports for which the UE is to report channel state information, and a second indication of a second number of antenna ports on which the UE is to measure channel state information reference signals, the second number of antenna ports being less than the first number of antenna ports; receiving an additional indication of one or more antenna port parameters, each associated with one of the first number of antenna ports or the second number of antenna ports, the one or more antenna port parameters comprising either an antenna port pattern or a transfer domain basis; determining the channel state information for the first number of antenna ports using the one or more antenna port parameters and measurements made by the UE on the second number of antenna ports; and transmitting a report comprising the channel state information for the first number of antenna ports.
Aspect 2: The method of aspect 1, wherein receiving the additional indication of the one or more antenna port parameters further comprises: receiving a message indicating a first set of antenna port patterns associated with the first number of antenna ports, and indicating a second set of antenna port patterns associated with the second number of antenna ports, wherein the second set of antenna port patterns are a subset of the first set of antenna port patterns.
Aspect 3: The method of aspect 2, wherein receiving the message indicating the first set of antenna port patterns and the second set of antenna port patterns further comprises: receiving the first set of antenna port patterns and the second set of antenna port patterns as a plurality of rectangular or linear antenna arrays with inter-antenna distance information.
Aspect 4: The method of any of aspects 2 through 3, wherein receiving the message indicating the first set of antenna port patterns and the second set of antenna port patterns further comprises: receiving one or more pattern indications that refer to a plurality of predefined antenna port patterns.
Aspect 5: The method of any of aspects 1 through 4, wherein receiving the additional indication of the one or more antenna port parameters further comprises: receiving a message indicating a first set of transfer domain bases associated with the first number of antenna ports, and indicating a second set of transfer domain bases associated with the second number of antenna ports, wherein the second set of transfer domain bases are a subset of the first set of transfer domain bases.
Aspect 6: The method of any of aspects 1 through 5, further comprising: receiving the first indication, the second indication, and the additional indication via at least one of a channel state information report configuration or a channel state information resource configuration.
Aspect 7: The method of aspect 6, wherein receiving the first indication, the second, indication, and the additional indication further comprises: receiving, via the channel state information report configuration, the first indication and the additional indication, wherein the additional indication indicates a first antenna port parameter associated with the first number of antenna ports and a second antenna port parameter associated with the second number of antenna ports; and receiving, via the channel state information resource configuration, the second indication.
Aspect 8: The method of any of aspects 6 through 7, wherein receiving the first indication, the second, indication, and the additional indication further comprises: receiving, via the channel state information report configuration, the second indication and the additional indication, wherein the additional indication indicates a first antenna port parameter associated with the first number of antenna ports and a second antenna port parameter associated with the second number of antenna ports; and receiving, via the channel state information resource configuration, the first indication.
Aspect 9: The method of any of aspects 6 through 8, further comprising: receiving, via a codebook configuration within the channel state information report configuration, one or more codebook types that are based at least in part on the first indication, the second indication, and the additional indication, wherein the additional indication indicates at least a first antenna port parameter associated with the second number of antenna ports.
Aspect 10: The method of any of aspects 6 through 9, wherein receiving the first indication, the second, indication, and the additional indication further comprises: receiving, via the channel state information resource configuration, the first indication, the second indication, and the additional indication, wherein the additional indication indicates a first antenna port parameter associated with the first number of antenna ports and a second antenna port parameter associated with the second number of antenna ports.
Aspect 11: The method of any of aspects 1 through 10, wherein determining the channel state information further comprises: identifying one or more precoding matrix indicators for the first number of antenna ports using the one or more antenna port parameters and measurements made by the UE on the second number of antenna ports.
Aspect 12: The method of aspect 11, further comprising: receiving a message indicating a precoding matrix codebook comprising a plurality of precoding matrix indicators, wherein the one or more precoding matrix indicators are identified from the precoding matrix codebook.
Aspect 13: The method of aspect 12, wherein receiving the message indicating the precoding matrix codebook further comprises: receiving a channel state information report configuration, the channel state information report configuration comprising the precoding matrix codebook.
Aspect 14: The method of any of aspects 12 through 13, wherein each precoding matrix indicator of the plurality of precoding matrix indicators is based at least in part on the first number of antenna ports, the second number of antenna ports, the one or more antenna port parameters, or a combination thereof.
Aspect 15: The method of any of aspects 1 through 14, further comprising: transmitting a signal indicating a preference of the UE for selecting the second number of antenna ports, wherein receiving the second indication of the second number of antenna ports is based at least in part on transmitting the signal indicating the preference.
Aspect 16: The method of aspect 15, wherein the preference comprises a value of second number of antenna ports, an antenna port pattern associated with the second number of antenna ports, or a transfer domain basis associated with the second number of antenna ports, or a combination thereof.
Aspect 17: A method for wireless communications at a base station, comprising: transmitting a first indication of a first number of antenna ports for which a UE is to report channel state information, and a second indication of a second number of antenna ports on which the UE is to measure channel state information reference signals, the second number of antenna ports being less than the first number of antenna ports; transmitting an additional indication of one or more antenna port parameters, each associated with one of the first number of antenna ports or the second number of antenna ports, the one or more antenna port parameters comprising either an antenna port pattern or a transfer domain basis; and receiving a report comprising the channel state information for the first number of antenna ports, the channel state information based at least in part on the one or more antenna port parameters and measurements made by the UE on the second number of antenna ports.
Aspect 18: The method of aspect 17, wherein transmitting the additional indication of the one or more antenna port parameters further comprises: transmitting a message indicating a first set of antenna port patterns associated with the first number of antenna ports, and indicating a second set of antenna port patterns associated with the second number of antenna ports, wherein the second set of antenna port patterns are a subset of the first set of antenna port patterns.
Aspect 19: The method of any of aspects 17 through 18, wherein transmitting the additional indication of the one or more antenna port parameters further comprises: transmitting a message indicating a first set of transfer domain bases associated with the first number of antenna ports, and indicating a second set of transfer domain bases associated with the second number of antenna ports, wherein the second set of transfer domain bases are a subset of the first set of transfer domain bases.
Aspect 20: The method of any of aspects 17 through 19, further comprising: transmitting the first indication, the second indication, and the additional indication via at least one of a channel state information report configuration or a channel state information resource configuration.
Aspect 21: The method of aspect 20, wherein transmitting the first indication, the second, indication, and the additional indication further comprises: transmitting, via the channel state information report configuration, the first indication and the additional indication, wherein the additional indication indicates a first antenna port parameter associated with the first number of antenna ports and a second antenna port parameter associated with the second number of antenna ports; and transmitting, via the channel state information resource configuration, the second indication.
Aspect 22: The method of any of aspects 20 through 21, wherein transmitting the first indication, the second, indication, and the additional indication further comprises: transmitting, via the channel state information report configuration, the second indication and the additional indication, wherein the additional indication indicates a first antenna port parameter associated with the first number of antenna ports and a second antenna port parameter associated with the second number of antenna ports; and transmitting, via the channel state information resource configuration, the first indication.
Aspect 23: The method of any of aspects 20 through 22, further comprising: transmitting, via a codebook configuration within the channel state information report configuration, one or more codebook types that are based at least in part on the first indication, the second indication, and the additional indication, wherein the additional indication indicates at least a first antenna port parameter associated with the second number of antenna ports.
Aspect 24: The method of any of aspects 20 through 23, wherein transmitting the first indication, the second, indication, and the additional indication further comprises: transmitting, via the channel state information resource configuration, the first indication, the second indication, and the additional indication, wherein the additional indication indicates a first antenna port parameter associated with the first number of antenna ports and a second antenna port parameter associated with the second number of antenna ports.
Aspect 25: The method of any of aspects 17 through 24, further comprising: transmitting a channel state information report configuration message indicating a precoding matrix codebook comprising a plurality of precoding matrix indicators, wherein each precoding matrix indicator of the plurality of precoding matrix indicators is based at least in part on the first number of antenna ports, the second number of antenna ports, or the one or more antenna port parameters, or a combination thereof.
Aspect 26: The method of any of aspects 17 through 25, further comprising: receiving a signal indicating a preference of the UE for selecting the second number of antenna ports, the preference comprising a value of second number of antenna ports, an antenna port pattern associated with the second number of antenna ports, or a transfer domain basis associated with the second number of antenna ports, or a combination thereof, wherein transmitting the second indication of the second number of antenna ports is based at least in part on transmitting the signal indicating the preference.
Aspect 27: The method of any of aspects 17 through 26, wherein transmitting the additional indication of the one or more antenna port parameters further comprises: transmitting a message indicating a first set of antenna port patterns associated with the first number of antenna ports, and indicating a second set of antenna port patterns associated with the second number of antenna ports, wherein the second set of antenna port patterns are a subset of the first set of antenna port patterns.
Aspect 28: The method of any of aspects 17 through 27, wherein transmitting the additional indication of the one or more antenna port parameters further comprises: transmitting a message indicating a first set of transfer domain bases associated with the first number of antenna ports, and indicating a second set of transfer domain bases associated with the second number of antenna ports, wherein the second set of transfer domain bases are a subset of the first set of transfer domain bases.
Aspect 29: An apparatus for wireless communications, comprising a processor; memory coupled with the processor; and instructions stored in the memory and executable by the processor to cause the apparatus to perform a method of any of aspects 1 through 16.
Aspect 30: An apparatus for wireless communications, comprising at least one means for performing a method of any of aspects 1 through 16.
Aspect 31: A non-transitory computer-readable medium storing code for wireless communications at a UE, the code comprising instructions executable by a processor to perform a method of any of aspects 1 through 16.
Aspect 32: An apparatus for wireless communications, comprising a processor; memory coupled with the processor; and instructions stored in the memory and executable by the processor to cause the apparatus to perform a method of any of aspects 17 through 28.
Aspect 33: An apparatus for wireless communications, comprising at least one means for performing a method of any of aspects 17 through 28.
Aspect 34: A non-transitory computer-readable medium storing code for wireless communications at a base station, the code comprising instructions executable by a processor to perform a method of any of aspects 17 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a first indication of a first number of antenna ports for which the UE is to report channel state information, and a second indication of a second number of antenna ports on which the UE is to measure channel state information reference signals, the second number of antenna ports being less than the first number of antenna ports;
receiving an additional indication of one or more antenna port parameters, each associated with one of the first number of antenna ports or the second number of antenna ports, the one or more antenna port parameters comprising either an antenna port pattern or a transfer domain basis;
determining the channel state information for the first number of antenna ports using the one or more antenna port parameters and measurements made by the UE on the second number of antenna ports; and
transmitting a report comprising the channel state information for the first number of antenna ports.

2. The method of claim 1, wherein receiving the additional indication of the one or more antenna port parameters further comprises:
receiving a message indicating a first set of antenna port patterns associated with the first number of antenna ports, and indicating a second set of antenna port patterns associated with the second number of antenna ports, wherein the second set of antenna port patterns are a subset of the first set of antenna port patterns.

3. The method of claim 2, wherein receiving the message indicating the first set of antenna port patterns and the second set of antenna port patterns further comprises:
receiving the first set of antenna port patterns and the second set of antenna port patterns as a plurality of rectangular or linear antenna arrays with inter-antenna distance information.

4. The method of claim 2, wherein receiving the message indicating the first set of antenna port patterns and the second set of antenna port patterns further comprises:
receiving one or more pattern indications that refer to a plurality of predefined antenna port patterns.

5. The method of claim 1, wherein receiving the additional indication of the one or more antenna port parameters further comprises:
receiving a message indicating a first set of transfer domain bases associated with the first number of antenna ports, and indicating a second set of transfer domain bases associated with the second number of antenna ports, wherein the second set of transfer domain bases are a subset of the first set of transfer domain bases.

6. The method of claim 1, further comprising:
receiving the first indication, the second indication, and the additional indication via at least one of a channel state information report configuration or a channel state information resource configuration.

7. The method of claim 6, wherein receiving the first indication, the second, indication, and the additional indication further comprises:
receiving, via the channel state information report configuration, the first indication and the additional indication, wherein the additional indication indicates a first antenna port parameter associated with the first number of antenna ports and a second antenna port parameter associated with the second number of antenna ports; and
receiving, via the channel state information resource configuration, the second indication.

8. The method of claim 6, wherein receiving the first indication, the second, indication, and the additional indication further comprises:
receiving, via the channel state information report configuration, the second indication and the additional indication, wherein the additional indication indicates a first antenna port parameter associated with the first number of antenna ports and a second antenna port parameter associated with the second number of antenna ports; and
receiving, via the channel state information resource configuration, the first indication.

9. The method of claim 6, further comprising:
receiving, via a codebook configuration within the channel state information report configuration, one or more codebook types that are based at least in part on the first indication, the second indication, and the additional indication, wherein the additional indication indicates at least a first antenna port parameter associated with the second number of antenna ports.

10. The method of claim 6, wherein receiving the first indication, the second, indication, and the additional indication further comprises:
receiving, via the channel state information resource configuration, the first indication, the second indication, and the additional indication, wherein the additional indication indicates a first antenna port parameter associated with the first number of antenna ports and a second antenna port parameter associated with the second number of antenna ports.

11. The method of claim 1, wherein determining the channel state information further comprises:
identifying one or more precoding matrix indicators for the first number of antenna ports using the one or more antenna port parameters and measurements made by the UE on the second number of antenna ports.

12. The method of claim 11, further comprising:
receiving a message indicating a precoding matrix codebook comprising a plurality of precoding matrix indicators, wherein the one or more precoding matrix indicators are identified from the precoding matrix codebook.

13. The method of claim 12, wherein receiving the message indicating the precoding matrix codebook further comprises:
receiving a channel state information report configuration, the channel state information report configuration comprising the precoding matrix codebook.

14. The method of claim 12, wherein each precoding matrix indicator of the plurality of precoding matrix indicators is based at least in part on the first number of antenna ports, the second number of antenna ports, the one or more antenna port parameters, or a combination thereof.

15. The method of claim 1, further comprising:
transmitting a signal indicating a preference of the UE for selecting the second number of antenna ports, wherein receiving the second indication of the second number of antenna ports is based at least in part on transmitting the signal indicating the preference.

16. The method of claim 15, wherein the preference comprises a value of second number of antenna ports, an antenna port pattern associated with the second number of antenna ports, or a transfer domain basis associated with the second number of antenna ports, or a combination thereof.

17. A method for wireless communications at a base station, comprising:
transmitting a first indication of a first number of antenna ports for which a user equipment (UE) is to report channel state information, and a second indication of a second number of antenna ports on which the UE is to measure channel state information reference signals, the second number of antenna ports being less than the first number of antenna ports;
transmitting an additional indication of one or more antenna port parameters, each associated with one of the first number of antenna ports or the second number of antenna ports, the one or more antenna port parameters comprising either an antenna port pattern or a transfer domain basis; and
receiving a report comprising the channel state information for the first number of antenna ports, the channel state information based at least in part on the one or more antenna port parameters and measurements made by the UE on the second number of antenna ports.

18. The method of claim 17, wherein transmitting the additional indication of the one or more antenna port parameters further comprises:
transmitting a message indicating a first set of antenna port patterns associated with the first number of antenna ports, and indicating a second set of antenna port patterns associated with the second number of antenna ports, wherein the second set of antenna port patterns are a subset of the first set of antenna port patterns.

19. The method of claim 17, wherein transmitting the additional indication of the one or more antenna port parameters further comprises:
transmitting a message indicating a first set of transfer domain bases associated with the first number of antenna ports, and indicating a second set of transfer domain bases associated with the second number of antenna ports, wherein the second set of transfer domain bases are a subset of the first set of transfer domain bases.

20. The method of claim 17, further comprising:
transmitting the first indication, the second indication, and the additional indication via at least one of a channel state information report configuration or a channel state information resource configuration.

21. The method of claim 20, wherein transmitting the first indication, the second, indication, and the additional indication further comprises:
transmitting, via the channel state information report configuration, the first indication and the additional indication, wherein the additional indication indicates a first antenna port parameter associated with the first number of antenna ports and a second antenna port parameter associated with the second number of antenna ports; and
transmitting, via the channel state information resource configuration, the second indication.

22. The method of claim 20, wherein transmitting the first indication, the second, indication, and the additional indication further comprises:
transmitting, via the channel state information report configuration, the second indication and the additional indication, wherein the additional indication indicates a first antenna port parameter associated with the first number of antenna ports and a second antenna port parameter associated with the second number of antenna ports; and
transmitting, via the channel state information resource configuration, the first indication.

23. The method of claim 20, further comprising:
transmitting, via a codebook configuration within the channel state information report configuration, one or more codebook types that are based at least in part on the first indication, the second indication, and the additional indication, wherein the additional indication indicates at least a first antenna port parameter associated with the second number of antenna ports.

24. The method of claim 20, wherein transmitting the first indication, the second, indication, and the additional indication further comprises:
transmitting, via the channel state information resource configuration, the first indication, the second indication, and the additional indication, wherein the additional indication indicates a first antenna port parameter associated with the first number of antenna ports and a second antenna port parameter associated with the second number of antenna ports.

25. The method of claim 17, further comprising:
transmitting a channel state information report configuration message indicating a precoding matrix codebook comprising a plurality of precoding matrix indicators, wherein each precoding matrix indicator of the plurality of precoding matrix indicators is based at least in part on the first number of antenna ports, the second number of antenna ports, or the one or more antenna port parameters, or a combination thereof.

26. The method of claim 17, further comprising:
receiving a signal indicating a preference of the UE for selecting the second number of antenna ports, the preference comprising a value of second number of antenna ports, an antenna port pattern associated with the second number of antenna ports, or a transfer domain basis associated with the second number of antenna ports, or a combination thereof, wherein transmitting the second indication of the second number of antenna ports is based at least in part on transmitting the signal indicating the preference.

27. The method of claim 17, wherein transmitting the additional indication of the one or more antenna port parameters further comprises:
transmitting a message indicating a first set of antenna port patterns associated with the first number of antenna ports, and indicating a second set of antenna port patterns associated with the second number of antenna ports, wherein the second set of antenna port patterns are a subset of the first set of antenna port patterns.

28. The method of claim 17, wherein transmitting the additional indication of the one or more antenna port parameters further comprises:
transmitting a message indicating a first set of transfer domain bases associated with the first number of antenna ports, and indicating a second set of transfer domain bases associated with the second number of antenna ports, wherein the second set of transfer domain bases are a subset of the first set of transfer domain bases.

29. An apparatus for wireless communications, comprising:
a processor;
memory coupled with the processor; and
instructions stored in the memory and executable by the processor to cause the apparatus to:
receive a first indication of a first number of antenna ports for which the UE is to report channel state information, and a second indication of a second number of antenna ports on which the UE is to measure channel state information reference signals, the second number of antenna ports being less than the first number of antenna ports;
receive an additional indication of one or more antenna port parameters, each associated with one of the first number of antenna ports or the second number of antenna ports, the one or more antenna port parameters comprising either an antenna port pattern or a transfer domain basis;
determine the channel state information for the first number of antenna ports using the one or more antenna port parameters and measurements made by the UE on the second number of antenna ports; and
transmit a report comprising the channel state information for the first number of antenna ports.

30. An apparatus for wireless communications, comprising:
a processor;
memory coupled with the processor; and
instructions stored in the memory and executable by the processor to cause the apparatus to:
transmit a first indication of a first number of antenna ports for which a user equipment (UE) is to report channel state information, and a second indication of a second number of antenna ports on which the UE is to measure channel state information reference signals, the second number of antenna ports being less than the first number of antenna ports;
transmit an additional indication of one or more antenna port parameters, each associated with one of the first number of antenna ports or the second number of antenna ports, the one or more antenna port parameters comprising either an antenna port pattern or a transfer domain basis; and
receive a report comprising the channel state information for the first number of antenna ports, the channel state information based at least in part on the one or more antenna port parameters and measurements made by the UE on the second number of antenna ports.
